(19) United States
(12) Patent Application Publication
(10) Pub. No.: US 2015/0372338 A1
(43) Pub. Date: Dec. 24, 2015

(54) NON-AQUEOUS ELECTROLYTE SECONDARY BATTERY, METHOD FOR MANUFACTURING POSITIVE ELECTRODE SHEET OF NON-AQUEOUS ELECTROLYTE SECONDARY BATTERY, AND METHOD FOR MANUFACTURING NON-AQUEOUS ELECTROLYTE SECONDARY BATTERY

(71) Applicant: TOYOTA JIDOSHA KABUSHIKI KAISHA, Toyota-shi (JP)

(72) Inventors: Kenji TSUCHIYA, Toyota-shi (JP); Shigeru SUZUKI, Okazaki-shi (JP); Takahiko NAKANO, Seto-shi (JP); Katsushi ENOKIHARA, Toyota-shi (JP); Atsushi SUGIHARA, Toyota-shi (JP); Shuji TSUTSUMI, Ikoma-shi (JP); Naoyuki WADA, Nagoya-shi (JP); Hideki SANO, Okazaki-shi (JP); Tatsuya HASHIMOTO, Osaka-shi (JP)

(73) Assignee: TOYOTA JIDOSHA KABUSHIKI KAISHA, Toyota-shi (JP)

(21) Appl. No.: 14/762,649

(22) PCT Filed: Dec. 9, 2013
(86) PCT No.: PCT/JP2013/082924

§ 371 Date: Jul. 22, 2015

(30) Foreign Application Priority Data
Feb. 8, 2013 (JP) 2013-023345

(51) Int. Cl. H01M 10/04; H01M 4/36; H01M 4/1391; H01M 4/1393; H01M 10/0525; H01M 4/04

(52) U.S. Cl. CPC H01M 10/0431; H01M 10/0525; H01M 4/0404; H01M 4/0471; H01M 4/0411; H01M 4/1391; H01M 4/1393; H01M 4/366

(57) ABSTRACT

A non-aqueous electrolyte secondary battery includes an electrode wound body formed by winding positive and negative electrode sheets with separators interposed therebetween. The positive electrode sheet is manufactured through a coating process wherein a positive electrode mixture paste is applied to a current collecting sheet to form a mixture layer. Prior to the coating process, sections of the current collecting sheet to be uncoated and to be coated are differentiated in terms of wettability. Alternatively, a positive electrode mixture paste with viscosities at slow and fast shear velocities within a predetermined range is used. Thus, the cross-sectional shape of the width-direction end of the mixture layer includes a steep cross-sectional shape, wherein the width of a section as thin as or thinner than 50% of a thickness of a width-direction center flat portion of the mixture layer is 100 μm or less.

### TECHNICAL FIELD

The present invention relates to a non-aqueous electrolyte secondary battery including an electrode wound body and a method for manufacturing the non-aqueous electrolyte secondary battery, and particularly to a method for manufacturing a positive electrode sheet of the battery. More particularly, the present invention relates to a non-aqueous electrolyte secondary battery configured to prevent elution of metal component from a width-direction end portion of a mixture layer in an outermost circumferential portion of an electrode wound body, a method for manufacturing a positive electrode sheet of the non-aqueous electrolyte secondary battery, and a method for manufacturing the non-aqueous electrolyte secondary battery.

### BACKGROUND ART

Heretofore, such a non-aqueous electrolyte secondary battery disclosed in Patent Document 1 for example generally employs an electrode wound body composed of a positive electrode sheet and a negative electrode sheet wound in overlapping relation with separators interposed therebetween. An electrode sheet of this type of non-aqueous electrolyte secondary battery is formed of a current collector sheet (a metal foil) formed with a mixture layer made of electrode active material. For forming the mixture layer on the current collector sheet, commonly, mixture paste made by kneading powder of the electrode active material and other components for the mixture layer with solvent is used. In other words, the mixture paste which is fluid material is applied or coated onto the current collector sheet and dried to form the mixture layer.

### RELATED ART DOCUMENTS

### Patent Documents

Patent Document 1: JP-A-2009-283270

### SUMMARY OF INVENTION

### Problems to be Solved by the Invention

However, the foregoing conventional art would cause the following problems. Specifically, in an end portion of the formed mixture layer, a thin layer region having a slant surface, resulting in a thin layer thickness, is inevitably generated due to fluidity and surface tension of the mixture paste. This thin layer region leads to a disadvantage that a battery capacity of the non-aqueous electrolyte secondary battery could not be sufficiently obtained. In this thin layer region, furthermore, metal elements are eluted due to a local increase in potential during charging. Elution of the metal elements would be especially problematic in the end portion of the positive electrode mixture layer for the following reason. In the electrode wound body of the non-aqueous electrolyte secondary battery of the above type, as shown in a cross-sectional schematic diagram of FIG. 1, a negative electrode mixture layer 21 is normally formed wider than a positive electrode mixture layer 31. Thus, lithium ions will diffuse to the negative electrode mixture layer 21 wider than the positive electrode mixture layer 31 (arrows A). Accordingly, an amount of escaping lithium ions per unit amount of active material is large in a thin layer region 31R of the end portion. In FIG. 1, separators are indicated by the reference sign “4”.

The above problem is especially serious on an outer surface side of an outermost circumferential portion of a positive electrode sheet in the electrode wound body. This is because the electrode wound body of this type of non-aqueous electrolyte secondary battery is configured such that a negative electrode sheet is located as an outermost circumferential electrode sheet. Thus, a mixture layer 21E on the outer surface side of the outermost circumferential portion of the negative electrode sheet does not face the mixture layer 31 of the positive electrode sheet. Even in this portion 21E, lithium ions escaped from the thin layer region 31R in the end portion of the positive electrode mixture layer 31 on the outer surface side of the outermost circumferential portion of the positive electrode sheet will diffuse by detouring around the negative electrode sheet (arrow B). This also additionally influences the local increase in potential in the thin layer region 31R, leading to elution of metal elements therefrom.

As above, the mixture layer end portion of the positive electrode sheet is apt to release a large amount of lithium ions during charging. However, the above-described mixture-layer end portion is formed as the thin layer region, which originally has a smaller amount of active material than other portions of the mixture layer. This leads to the foregoing problems. The technique of Patent Document 1 is also configured to address a negative effect resulting from the thin layer region. However, this technique of Patent Document 1 could still generate a thin layer region with a width on the order of millimeter. Thus, it would be insufficient to prevent the negative effect by the thin layer region.

The present invention has been made to solve the above problems and has a purpose to provide a non-aqueous electrolyte secondary battery configured to enable effectively preventing a problem due to a thin layer region in an end portion of a mixture layer, a method for manufacturing a positive electrode sheet of the non-aqueous electrolyte secondary battery, and a method for manufacturing the non-aqueous electrolyte secondary battery.

### Means of Solving the Problems

To achieve the above purpose, a first aspect of the invention provides a non-aqueous electrolyte secondary battery having an electrode wound body including a positive electrode sheet and a negative electrode sheet, which are wound in overlapping relation with separators interposed therebetween, wherein an outermost circumferential electrode sheet of the electrode wound body is the negative electrode sheet, and the positive electrode sheet is configured such that a mixture layer formed on an outer surface of an outermost circumferential portion has an end portion in a width direction having a steep cross sectional shape in which a portion as thin as or thinner than 50% of a thickness of a flat portion of the mixture layer at a center in the width direction has a width of 100 μm or less. Since the width-direction end portion of the mixture layer has such a steep cross sectional shape, it is possible to effectively prevent any problem due to a thin layer region.

Further, a second aspect of the invention provides a method for manufacturing a positive electrode sheet of a non-aqueous electrolyte secondary battery having an electrode wound body including a positive electrode sheet and a negative electrode sheet, which are wound in overlapping relation with separators interposed therebetween, wherein the method comprises a coating step of coating positive electrode mixture paste onto a current collector sheet to form a mixture layer, and the mixture layer to be formed in the coating step has an end portion in a width direction having a steep cross sectional shape in which a portion as thin as or thinner than 50% of a thickness of a flat portion of the mixture layer at a center in the width direction has a width of 100 μm or less in at least the outermost circumferential region on a surface which will be an outer surface of the electrode wound body.

Herein, according to the first method for manufacturing a positive electrode sheet of a non-aqueous electrolyte secondary battery in the second aspect, prior to the coating step, wettability adjusting treatment is performed on at least an outer surface of an outermost circumferential region of the current collector sheet in a longitudinal direction, the outermost circumferential region corresponding to a range which will be placed on an outermost circumference of the electrode wound body, to adjust a wettability value NA of a width-direction end portion to be formed as an uncoated portion and a wettability value NB of a width-direction central portion to be formed as a coated portion at a ratio NA/NB expressed by

0.5<NA/NB<1.

By this wettability adjusting treatment, a steep cross sectional shape of the end portion of the foregoing mixture layer in the width direction is achieved. This is because the positive electrode mixture paste is uniformly applied onto the coated portion having high wettability, while the positive electrode mixture paste is repelled in the uncoated portion having low wettability.

The wettability adjusting treatment may include at least one of a treatment of decreasing wettability of the width-direction end portion of the current collector sheet and a treatment of increasing wettability of the width-direction central portion of the current collector sheet. The treatment of decreasing the wettability may include an oil coating process or a water-repellent material coating process in the case where the decreasing treatment is performed. The treatment of increasing the wettability may include a corona discharge treatment, a roughening treatment, and a cleaning treatment using solvent in the case where the increasing treatment is performed. The wettability adjusting treatment may be performed over an entire region of the current collector sheet in the longitudinal direction or may performed on only a range of an entire region of the current collector sheet in the longitudinal direction, the range being to be disposed on the outermost circumference of the electrode wound body.

In a second method for manufacturing a positive electrode sheet of a non-aqueous electrolyte secondary battery according to the second aspect, the coating step uses positive electrode mixture paste having a TI value falling within a range of 1.7 to 4.6, the TI value being a ratio between viscosity at a shear rate of 2 s⁻¹ and viscosity at a shear rate of 100 s⁻¹ at 20° C. Accordingly, the steep cross sectional shape of the end portion of the mixture layer in the width direction is achieved. This is because the viscosity of the positive electrode mixture paste is low during coating in which the shear rate or velocity is fast, while the viscosity is high after coating in which the shear rate is slow.

According to the method for manufacturing a positive electrode sheet of a non-aqueous electrolyte secondary battery in the second aspect of the invention, preferably, a drying step of drying the mixture layer formed in the coating step is performed. On an entrance side in the drying step, it is preferable to make the end portion of the mixture layer in the width direction lower in temperature than the central portion in the width direction. This is because drying can be promoted while suppressing viscosity reduction due to a temperature rise in the width-direction end portion of the mixture layer. For this purpose, a back surface of the current collector sheet after the coating step is supported by a supporting roller, and the supporting roller is an end-portion cooling roller having cooling zones in end portions in a width direction and a non-cooling zone between the cooling zones. Alternatively, the supporting roller may be a central-portion heating roller having a heating zone in a central portion in a width direction and non-heating zones at both ends.

A method for manufacturing the non-aqueous electrolyte secondary battery of the invention uses a positive electrode sheet manufactured by any one of the foregoing manufacturing methods, together with a negative electrode sheet and separators, and comprises a winding step of winding the positive electrode sheet and the negative electrode sheet in overlapping relation with the separators interposed therebetween to form an electrode wound body. In this winding step, the negative electrode sheet is disposed as an outermost circumferential electrode sheet of the electrode wound body, and the portion having the steep cross sectional shape, of the end portion of the mixture layer in the width direction, is placed on at least an outer surface of an outermost circumferential portion of the positive electrode sheet.

### Effects of the Invention

According to the foregoing structure, there are provided a non-aqueous electrolyte secondary battery capable of effectively preventing a problem due to a thin layer region in an end portion of a mixture layer, a method for manufacturing a positive electrode sheet of the non-aqueous electrolyte secondary battery, and a method for manufacturing the non-aqueous electrolyte secondary battery.

### BRIEF DESCRIPTION OF THE DRAWINGS

FIG. 1 is a cross-sectional schematic diagram to explain escape of lithium ions from a thin layer region in an end portion of a mixture layer;

FIG. 2 is a perspective view of a battery in an embodiment;

FIG. 3 is a cross-sectional schematic diagram of an electrode wound body in the embodiment;

FIG. 4 is a cross sectional view showing a shape of the mixture layer of a positive electrode sheet in the embodiment;

FIG. 5 is a plan view showing layout of regions with different wettability in a current collector sheet which will constitute a positive electrode sheet;

FIG. 6 is a plan view showing a state of the current collector sheet of FIG. 5 formed with the mixture layer, and slit positions therein;

FIG. 7 is a plan view of another example showing layout of regions with different wettability in a current collector sheet which will constitute a positive electrode sheet;

FIG. 8 is a plan view showing a state of the current collector sheet of FIG. 7 formed with the mixture layer, and slit positions therein;

FIG. 9 is a plan view showing a part of the positive electrode sheet of FIG. 8, corresponding to one electrode wound body;

FIG. 10 is a plan view of still another example showing layout of regions with different wettability in a positive electrode sheet which will constitute a positive electrode sheet;

FIG. 11 is a plan view showing a state of the current collector sheet of FIG. 10 formed with the mixture layer, and slit positions therein;

FIG. 12 is a front view of a device configured to apply a mixture layer to a current collector sheet with a wettability difference;

FIG. 13 is a plan view of a mask of a corona discharge treatment section;

FIG. 14 is a front view of another device configured to apply a mixture layer to a current collector sheet with a wettability difference;

FIG. 15 is a perspective view of a roughening roller in a roughening treatment section;

FIG. 16 is a graph showing a relationship between shear rate and viscosity of mixture paste of positive active material;

FIG. 17 is a graph showing a relationship between temperature and viscosity of mixture paste of positive active material;

FIG. 18 is a cross sectional view of a structure of a support roller used in the embodiment;

FIG. 19 is a cross sectional view of a structure of another support roller in the embodiment;

FIG. 20 is a diagram including in combination a front view showing a device configured to dry with a temperature difference in a width direction, and a graph showing histories of temperature and solvent amount of an electrode sheet to be dried;

FIG. 21 is a cross sectional view showing a drying furnace configured to dry with a different temperature in a width direction; and

FIG. 22 is a graph showing a relationship between TI value of mixture paste of positive active material and size of an end region in a cross sectional shape of a mixture layer.

### MODE FOR CARRYING OUT THE INVENTION

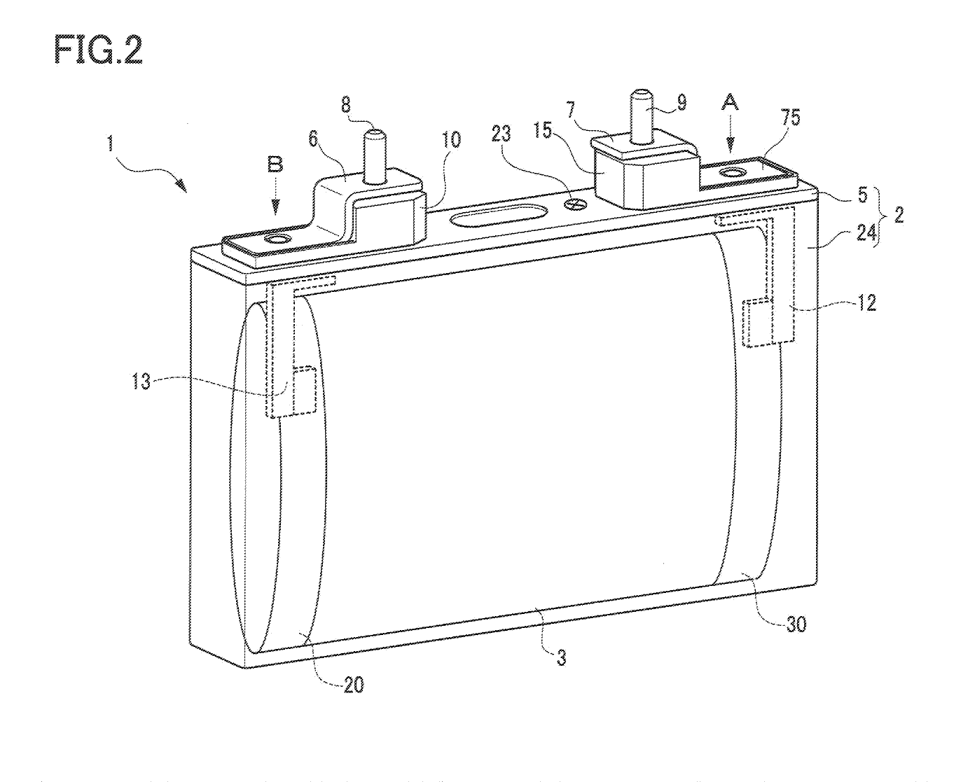

A detailed description of a preferred embodiment of the present invention will now be given referring to the accompanying drawings. In the present embodiment, the invention is applied onto a positive electrode sheet of a battery 1 as shown in FIG. 2. The battery 1 is a lithium ion secondary battery. The battery 1 in FIG. 2 includes a battery case 2 and an electrode wound body 3 accommodated therein. The battery case 2 is a member defining an outer shape of the battery 1. The battery case 2 consists of a case body 24 and a lid member 5. To this lid member 5, external terminal plates 6 and 7 are attached. These external terminal plates 6 and 7 secure bolts 8 and 9 respectively. Between the external terminal plates 6 and 7 and the lid member 5, insulating members 10 and 15 are placed. The lid member 5 of the battery 1 is provided with a liquid inlet 23 in addition to the above.

The electrode wound body 3 is an assembly formed by overlapping and winding a positive electrode sheet and a negative electrode sheet with separators interposed therebetween. Furthermore, the electrode wound body 3 is impregnated with electrolyte. This electrode wound body 3 is a power generating element of the battery 1. At both ends of the electrode wound body 3 in a direction parallel to a winding axis direction, there are provided a region 20 in which only a negative electrode sheet is present and a region 30 in which only a positive electrode sheet is present. The region 20 and the external terminal plate 6 are connected through a current collecting member 13. Further, the region 30 and the external terminal plate 7 are connected through a current collecting member 12.

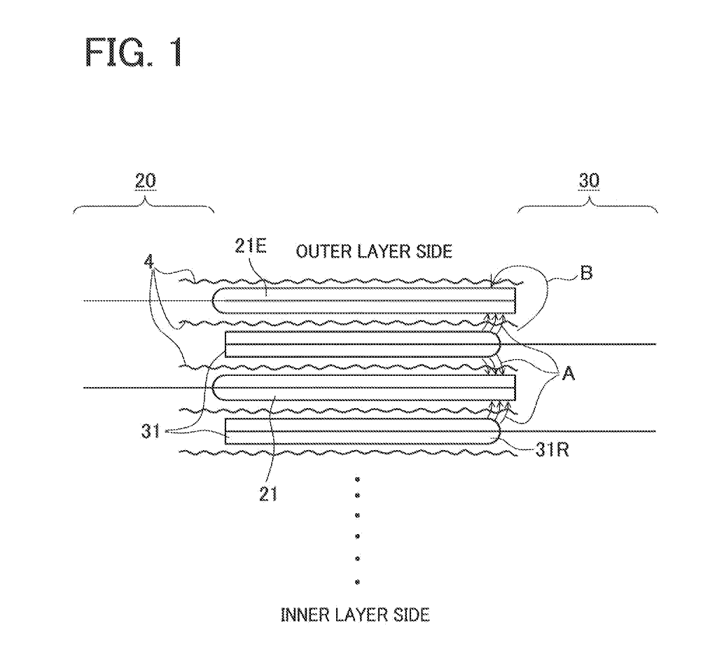

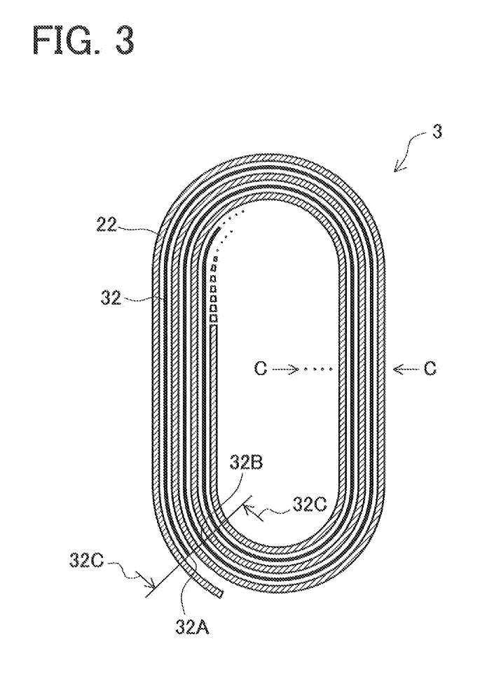

The electrode wound body 3 will be further explained. The electrode wound body 3 is constituted of a negative electrode sheet 22 and a positive electrode sheet 32 which are wound in overlapping relation as shown in a cross-sectional schematic view of FIG. 3. In an actual electrode wound body 3, separators are also wound together with a positive electrode sheet 32 and a negative electrode sheet 22 in layers. In FIG. 3, however, the electrode wound body 3 is illustrated by omitting the separators. In the actual electrode wound body 3, the separators 4 shown in FIG. 1 are unexceptionally interposed alternately between the negative electrode sheet 22 and the positive electrode sheet 32, so that the positive electrode sheet 32 and the negative electrode sheet 22 do not directly contact each other.

As seen in FIG. 3, out of the positive electrode sheet 32 and the negative electrode sheet 22, it is the negative electrode sheet 22 that is located on an outermost circumference of the electrode wound body 3. Even though an actual outermost layer of the electrode wound body 3 is a separator, the “outermost circumference” in the present description is deemed to consider only the positive electrode sheet 32 and the negative electrode sheet 22 without respect to the separator. A part of the positive electrode sheet 32, extending from an outermost end 32A to a point 32B located inside by one turn from the outermost end 32A, is referred to as an outermost circumferential portion 32C of the positive electrode sheet 32, because the positive electrode sheet 32 is absent more outside than the outermost circumferential portion 32C. The outermost circumferential portion 32C of the positive electrode sheet 32 is located just inside one outermost circumferential turn portion of the negative electrode sheet 22.

The cross-sectional schematic diagram shown in FIG. 1 corresponds to a cross sectional view taken along a line C-C in FIG. 3. The positive electrode sheet 32 and the negative electrode sheet 22 are each made of a current collector sheet (a metal foil) applied with electrode active material paste as a mixture layer, which will be explained later. Even in the electrode wound body 3 of the present embodiment, the mixture layer of the negative electrode sheet 22 is wider than the mixture layer of the positive electrode sheet 32, similarly to FIG. 1, but such a difference in width is slight. The width of the mixture layer of the electrode wound body 3 represents the size of the mixture layer in a lateral (right and left) direction in FIG. 2.

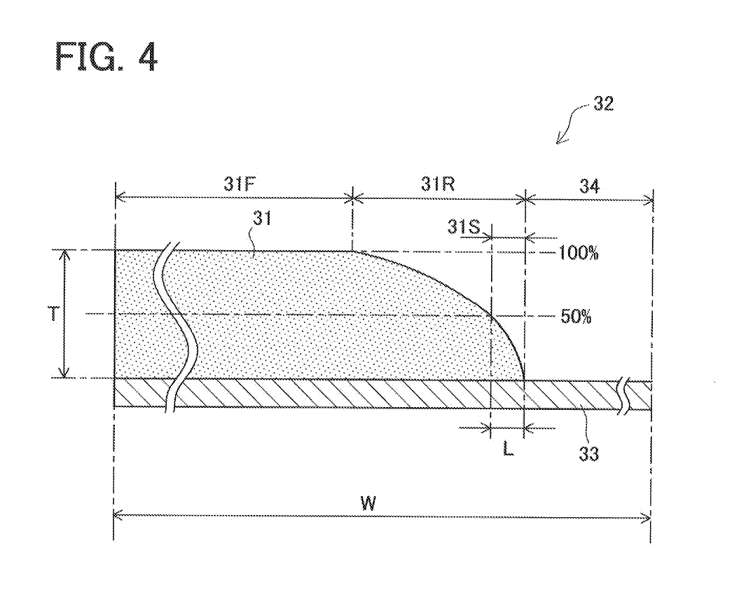

A cross sectional view of the positive electrode sheet 32 of the present embodiment is shown in FIG. 4. FIG. 4 is a cross sectional view along a line C-C in FIG. 3. A lateral direction in FIG. 4 corresponds to the lateral direction in FIG. 2. The positive electrode sheet 32 is formed of a current collector sheet 33 made of aluminum, on the surface of which a positive electrode mixture layer 31 is formed. In FIG. 4, the positive electrode mixture layer 31 is illustrated on only one surface of the current collector sheet 33; however, the positive electrode mixture layer 31 is actually present on each surface of the current collector sheet 33.

The positive electrode mixture layer 31 is not formed over the entire region of the current collector sheet 33. Near a right end in FIG. 4, an uncoated portion 34 formed with no positive electrode mixture layer 31 is present. In the uncoated portion 34, both front and back surfaces are not formed with the positive electrode mixture layer 31, so that the surfaces of the current collector sheet 33 are exposed. In FIG. 4, on a left end side, the uncoated portion 34 is not present. Accordingly, the positive electrode mixture layer 31 is formed over and on both surfaces of the entire positive electrode sheet 32 except for the uncoated portion 34 on the right end side in FIG. 4. A portion of the current collector sheet 33 formed with the positive electrode mixture layer 31 is positioned in a region between the region 20 and the region 30 in the electrode wound body 3 in FIG. 2. On the other hand, a portion of the current collector sheet 33 provided as the uncoated portion 34 is positioned in the region 30 in FIG. 2.

As is clear from FIG. 4, the positive electrode mixture layer 31 includes, near a boundary with the uncoated portion 34, a thin layer region 31R having a sloped surface and thus a decreasing layer thickness. A portion having a flat surface and a uniform layer thickness, other than the thin layer region 31R, in the positive electrode mixture layer 31 is referred to as a flat region 31F. The layer thickness of the flat region 31F of the positive electrode mixture layer 31 is indicated by “T”. Of the thin layer region 31R, especially, a portion having a layer thickness below half of the layer thickness T of the flat region 31F is referred to as an end edge region 31S with a width indicated by “L”. The thin layer region 31R is inevitably generated; however, in the present embodiment, the width L of the end edge region 31S on at least the outer surface side of the outermost circumferential portion 32C is reduced to as very small as 100 μm or less. In the present embodiment, as described above, an end portion of the positive electrode mixture layer 31 in the width direction (a width-direction end portion) has a cross sectional shape including a steep cross sectional shape of the end edge region 31S having a small width.

The negative electrode sheet 22 of the present embodiment is also configured in a similar manner to the positive electrode sheet 32 shown in FIG. 4. The material of a current collector sheet is however copper, not aluminum. The material of a mixture layer is also naturally different. An uncoated portion of the negative electrode sheet 22 is disposed on an opposite side to the uncoated portion 34 of the positive electrode sheet 32 in the electrode wound body 3, that is, positioned in the region 20 in FIG. 2. The negative electrode mixture layer does not need to meet the condition of the end edge width of the positive electrode mixture layer 31.

Next, a method for manufacturing the positive electrode sheet 32 including the end edge region 31S with a small width L as described above will be explained. In the present embodiment, similarly, the positive electrode sheet 32 is manufactured in such a way that mixture paste of positive active material is applied onto an aluminum foil which is the current collector sheet 33 to form the positive electrode mixture layer 31. Herein, two ways are available for forming the end edge region 31S with a small width L; one is to subject the current collector sheet 33 to surface treatment in advance and the other is to use special mixture paste.

### First Embodiment

Of the foregoing ways, the way of subjecting the current collector sheet 33 to surface treatment in advance will be explained below as the first embodiment. In this first embodiment, prior to a coating treatment, the current collector sheet 33 made of an aluminum foil is subjected to a treatment for producing a wettability difference between a portion which is to be formed thereon with the positive electrode mixture layer 31 and a portion which is to be formed as the uncoated portion 34. Naturally, the wettability of the portion to be formed with the positive electrode mixture layer 31 is made high and the wettability of the portion to be formed as the uncoated portion 34 is made low. This prevents the mixture paste applied on the portion to be formed with the positive electrode mixture layer 31 from flowing onto the portion to be formed as the uncoated portion 34.

If the wettability of the portion to be formed as the uncoated portion 34 is high, the width L of the end edge region 31S of the positive electrode mixture layer 31 to be formed is apt to be large. Even if the mixture paste is applied onto only on the portion to be formed with the positive electrode mixture layer 31, the coated mixture paste could flow and move to the portion to be formed as the uncoated portion 34. Accordingly, the amount of mixture per area is decreased at and around an edge of the positive electrode mixture layer 31. On the other hand, if the wettability of the portion to be formed with the positive electrode mixture layer 31 is low, it conversely causes a negative effect that is likely to generate pinhole(s) in the positive electrode mixture layer 31. The surface of the current collector sheet 33 is given a wettability difference in advance, so that the positive electrode mixture layer 31 can be formed with the end edge portion having a good cross sectional shape and having no pinhole.

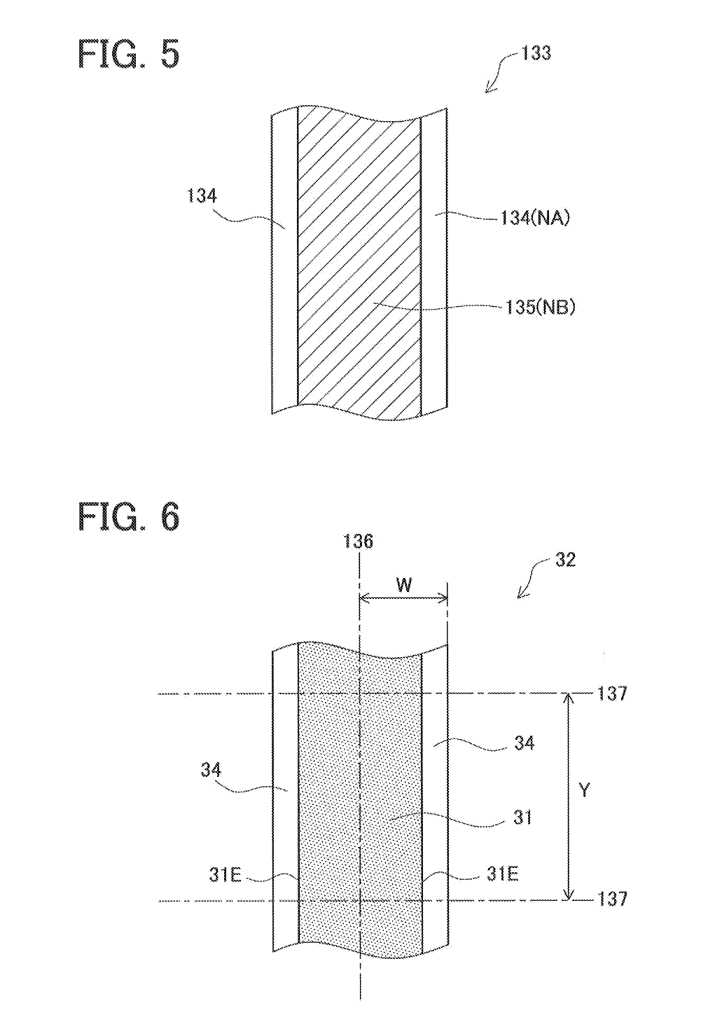

To be concrete, the wettability difference is produced as shown in FIG. 5. Specifically, of a long strip-shaped aluminum foil 133 for forming the current collector sheet 33, each end portion in the width direction (a lateral direction in FIG. 5) is provided with a low-wettability region 134. A portion between the region 134 and the region 134, that is, a central portion of the aluminum foil 133 in the width direction is provided with a high-wettability region 135. Needless to say, the positive electrode mixture layer 31 is formed on the region 135, and the regions 134 will become the uncoated portions 34.

The foregoing differentiating into the regions 134 and the region 135 may be performed on both, front and back, surfaces of the aluminum foil 133 for forming the current collector sheet 33 or may be performed on only one surface. In the case of performing the differentiating on only one surface, the surface subjected to the differentiating will be an outward facing surface of the electrode wound body 3. The differentiating on only one surface is more advantageous in terms of cost. However, this needs to manage the orientation of the front and back surfaces of the positive electrode sheet 32 in a winding step. The differentiating on both the surfaces may cost more, but does not need to manage the orientation of the front and back surfaces of the positive electrode sheet 32 in a winding step.

A concrete method for making a wettability difference between the regions 134 and the region 135 is classified into two ways; decreasing the wettability of the regions 134 and increasing the wettability of the region 135. Only either one of the two ways may be performed or both the ways may be carried out. The way of decreasing the wettability of the regions 134 may include coating the relevant portion with a low wettability component. This low wettability component may include various kinds of grease and water repellent material (fluorine contained resin, silicone, etc.). The way of increasing the wettability of the region 135 may include corona discharge treatment, roughening treatment, cleaning treatment using solvent, and others.

Herein, an explanation is given to the extent of a wettability difference between the regions 134 and the region 135. The wettability is represented by a lower value for lower wettability and a higher value for higher wettability. Thus, the magnitude relation between the wettability NA of the regions 134 and the wettability NB of the region 135 is NA<NB.

In the present embodiment, furthermore, the ratio of the wettability NA to the wettability NB (NA/NB) is set in a range of

0.5<NA/NB<1.

Measuring the wettability can be performed by any known method. In examples mentioned later, the wettability is evaluated in terms of a repellent degree of wettability evaluation reagent. The evaluation reagent used was a wetting tension test liquid mixture made by Wako Pure Chemical Industries, Ltd. As another way, there is also an evaluation method by measurement of a contact angle.

FIG. 6 shows a state of the aluminum foil 133 of FIG. 5 formed with the positive electrode mixture layer 31. In the positive electrode sheet 32 of FIG. 6, the regions 134 of FIG. 5 are the uncoated portions 34. Further, the positive electrode mixture layer 31 is formed over the entire region 135 of FIG. 5. In the positive electrode sheet 32 of FIG. 6, both side edge portions 31E of the positive electrode mixture layer 31 each have a cross sectional shape in which the width L of the end edge region 31R as shown in FIG. 4 is equal to or less than 100 μm.

In FIG. 6, the slit positions of the positive electrode sheet 32 to be cut are indicated by alternate long and short dashed lines. Specifically, the positive electrode sheet 32 will be cut into two in the width direction along a width-direction center line 136.

The positive electrode sheet 32 will be further cut along lines 137 extending in a lateral direction in FIG. 6 to each length Y in a longitudinal direction. This length Y corresponds to the length of the positive electrode sheet 32 required to produce one electrode wound body 3. The width W, half of the overall width of the positive electrode sheet 32, shown in FIG. 6 corresponds to the overall width of the positive electrode sheet 32 shown in FIG. 4.

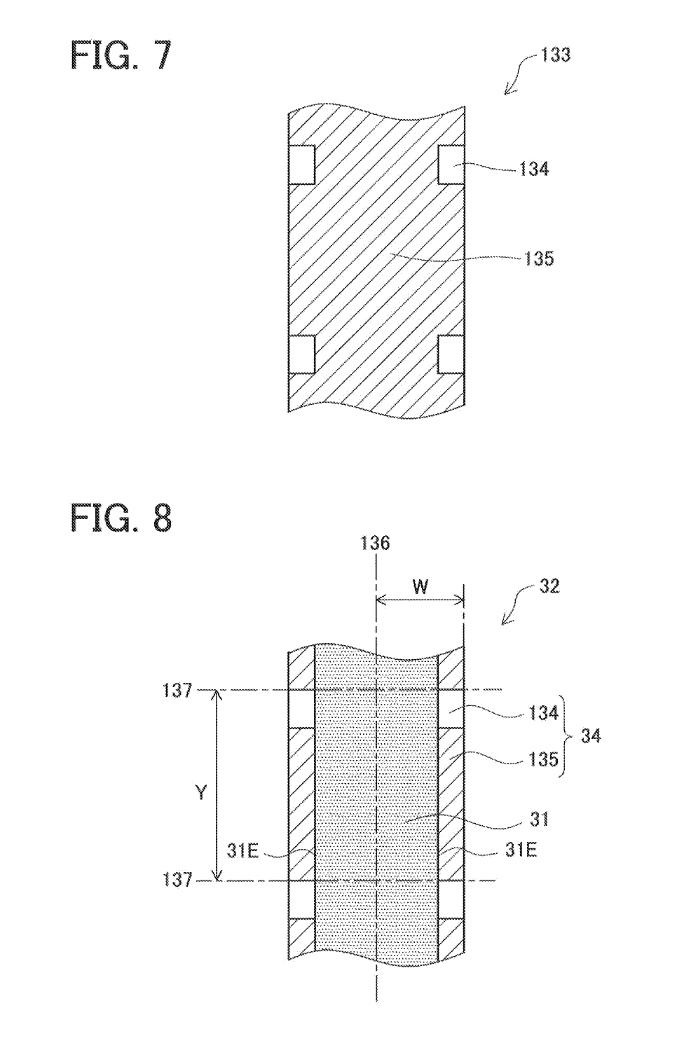

Layout of the regions 134 and the region 135 in the aluminum foil 133 is not limited to one shown in FIG. 5, but also may be one shown in FIG. 7. The layout in FIG. 5 provides the low wettability regions 134 extending all over the longitudinal direction of the aluminum foil 133 (a vertical direction in FIG. 5). On the other hand, the regions 134 provided by layout in FIG. 7 are formed intermittently in the longitudinal direction, so that an entire portion except for the portions formed with the regions 134 is formed as the region 135. This layout in FIG. 7 is suitable for the method of partially decreasing the wettability of the surface of the aluminum foil 133 originally having good wettability to form the regions 134. A back surface in the example shown in FIG. 7 may be configured in any form; having no regions 134, having a similar configuration to the front surface (i.e., FIG. 7), and having the regions 134 each continuously extending in the longitudinal direction (i.e., similar to FIG. 5).

FIG. 8 shows a state of the aluminum foil 133 of FIG. 7 formed with the positive electrode mixture layer 31. In the positive electrode sheet 32 of FIG. 8, not only the regions 134 of FIG. 7 but also side edge portions of the region 135 are also formed as the uncoated portions 34. Arrangement of the positive electrode mixture layer 31 and the uncoated portions 34 are equal between FIG. 6 and FIG. 8. Even in the positive electrode sheet 32 of FIG. 8, at positions with the regions 134, the both side edge portions 31E of the positive electrode mixture layer 31 each have the cross sectional shape shown in FIG. 4.

In FIG. 8, similar to FIG. 6, the slit positions of the positive electrode sheet 32 to be cut are indicated by alternate long and short dashed lines. Specifically, the positive electrode sheet 32 will be cut into two in the width direction along a center line 136 (the width W) and further cut along lines 137 to each length Y in a longitudinal direction. The width W and the length Y represent the same meanings as those in FIG. 6. In each range defined by the length Y, the region 134 is present in one location. The region 134 is located at an end of the range of the length Y.

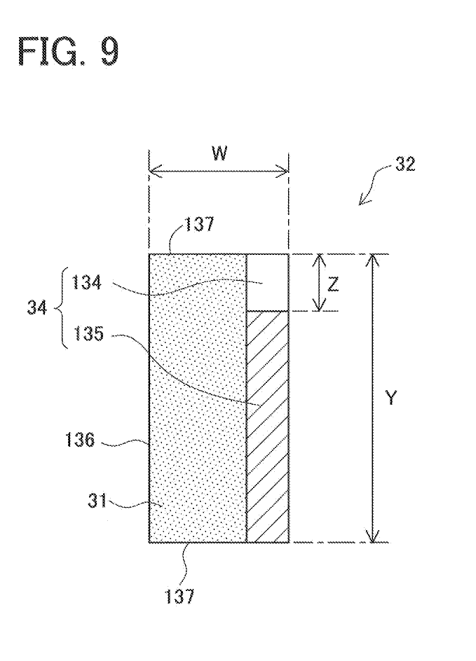

FIG. 9 is a plan view of the positive electrode sheet 32 corresponding to one electrode wound body 3, obtained by cutting the positive electrode sheet 32 of FIG. 8 along the line 136 and the lines 137. In FIG. 9, a dimension Z of the region 134 in the vertical direction corresponds to a winding length of the outermost circumferential portion 32C of the positive electrode sheet 32 of the electrode wound body 3 in FIG. 3. In other words, the length from the outermost end 32A to the one-turn inside point 32B of the positive electrode sheet 32 in FIG. 3 is equal to the dimension Z in FIG. 9. In the positive electrode sheet 32 of FIG. 9, of both ends in the longitudinal direction (the vertical direction), one end with no region 134, i.e., a lower end is a winding start end in the winding step, and the other end with the region 134, i.e., an upper end is a winding termination end. The surface shown in FIG. 9 is disposed facing outward in the electrode wound body 3.

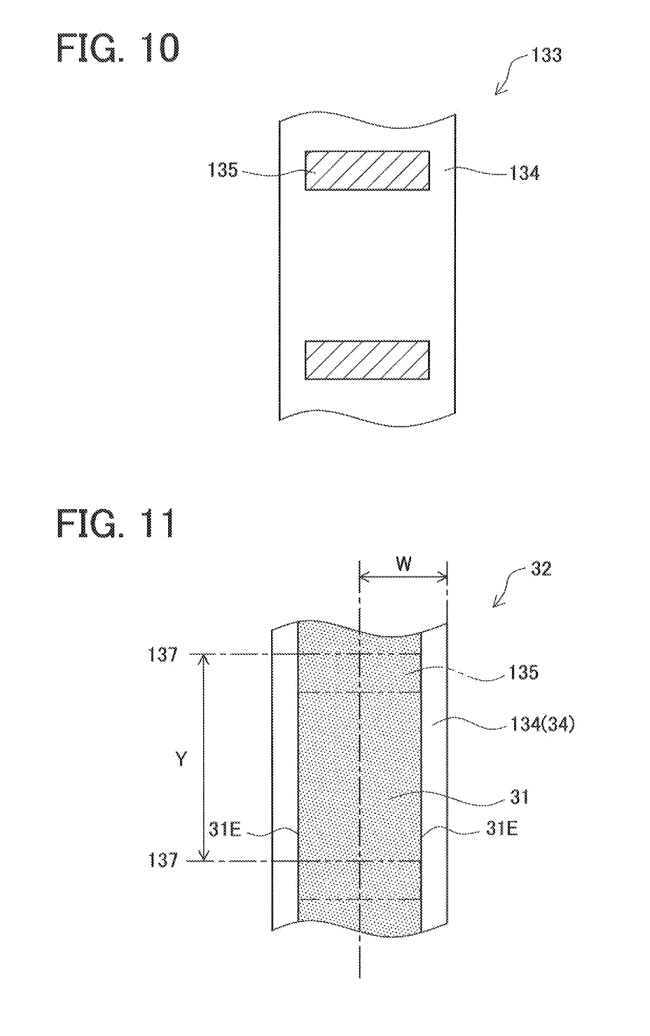

Layout of the regions 134 and the region 135 in the aluminum foil 133 may be performed as shown in FIG. 10 instead of FIGS. 5 and 7. In FIG. 7, the layout provides the regions 134 formed intermittently in the longitudinal direction, and the remaining region is entirely formed as the region 135. In FIG. 10, reversely, the regions 135 are formed intermittently in the longitudinal direction, and the remaining region is entirely formed as the region 134. This layout in FIG. 10 is suitable for the method of partially increasing the wettability of the surface of the aluminum foil 133 originally having low wettability to form the region 135. A back surface in the example shown in FIG. 10 may be configured in any form; having no regions 135, having a similar configuration to the front surface (i.e., FIG. 10), and having the regions 135 each continuously extending in the longitudinal direction (i.e., similar to FIG. 5).

FIG. 11 shows a state of the aluminum foil 133 of FIG. 10 formed with the positive electrode mixture layer 31. In the positive electrode sheet 32 of FIG. 11, the positive electrode mixture layer 31 is formed not only on the region 135 of FIG. 10 but also on a part of the region 134 except for both end portions thereof in the width direction. The arrangement of the positive electrode mixture layer 31 and the uncoated portions 34 is the same among FIGS. 6, 8, and 11. In the positive electrode sheet 32 of FIG. 11, on a portion with the region 135, both side edge portions 31E of the positive electrode mixture layer 31 each have a cross sectional shape shown in FIG. 4.

In FIG. 11, similar to FIGS. 6 and 8, the slit positions of the positive electrode sheet 32 to be cut are indicated by alternate long and short dashed lines. A cutting manner is similar to that in FIGS. 6 and 8. The width W and the length Y represent the same meanings as those in FIGS. 6 and 8. Thus, in the case shown in FIG. 11, a portion with the region 135 is present one in each range defined by the length Y. The region 135 is located at an end of the range with the length Y and will be disposed as a winding termination end on the outer surface side during winding.

The treatment of intermittently differentiating into the end portions and the central portion as shown in FIGS. 7 and 10 may be advantageous in terms of treatment cost. However, this needs to manage the orientation of the positive electrode sheet 32 at the winding start and the winding termination in the winding step. The continuous treatment as shown in FIG. 5 may cost much, but does not need to manage the orientation of the positive electrode sheet 32 in the winding step.

Next, an apparatus structure to achieve the differentiating into the region(s) 134 and the region(s) 135 as shown in FIGS. 5, 7, and 10 will be explained. The following explanation is given under the condition that the continuous process of coating the positive electrode mixture layer 31 is performed immediately after the differentiating is carried out.

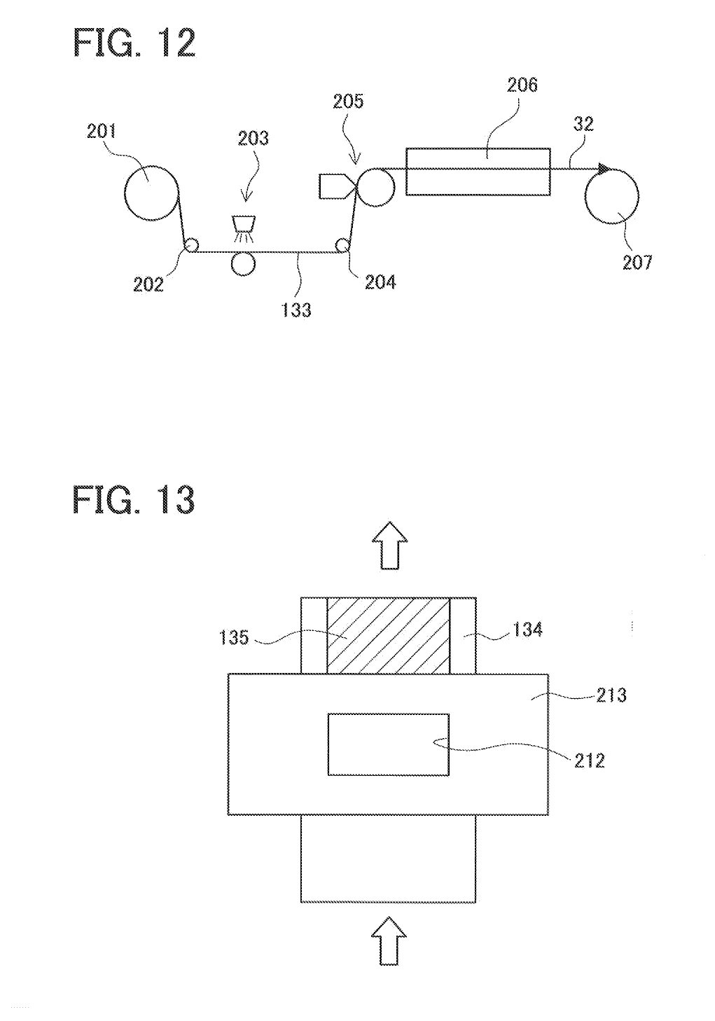

FIG. 12 shows the apparatus structure for differentiating by use of corona discharge treatment. The apparatus of FIG. 12 includes a wind-off roll 201, a first roller 202, a corona discharge treatment section 203, a second roller 204, a die-coating section 205, a drying furnace 206, and a wind-up roller 207. In this apparatus, an untreated aluminum foil is wound in the wind-off roll 201. The untreated aluminum foil wound off from the wind-off roll 201 travels along a path under tension applied by the first roller 202 and the second roller 204 toward the wind-up roll 207, and then wound up thereon. In the course of traveling, the aluminum foil is subjected to discharge treatment in the corona discharge treatment section 203, coating in the die-coating section 205, and drying in the drying furnace 206.

In the corona discharge treatment section 203, the aluminum foil is partially subjected to the corona discharge treatment. Of the surface of the aluminum foil, a portion subjected to the corona discharge treatment is increased in wettability. Thus, the portion subjected to the corona discharge treatment forms the region 135 and the remaining portions not subjected thereto form the regions 134. The corona discharge treatment section 203 may employ for example a “Corona Master” by Shinko Electrical Instrumentation Co., Ltd. and any device having the equivalent function thereto. In the examples mentioned later, a “Corona Mater PS-1” was used.

The corona discharge treatment section 203 has a mask 213 shown in FIG. 13. This mask 213 is formed with a window 212. In the range of the window 212, the aluminum foil is subjected to the corona discharge treatment. Outside the range of the window 212, the corona discharge treatment is blocked by the mask 213. The mask 213 is placed so that the window 212 faces a part of the aluminum foil in the width direction, i.e., a portion which will form the region 135, and covers a remaining part.

The surface of the aluminum foil 133 having passed through the corona discharge treatment section 203 as above is thus differentiated into the regions 134 and the region 135 as shown in FIG. 5. It is to be noted that the corona discharge treatment may be performed intermittently to achieve the layout shown in FIG. 10. As another alternative, the corona discharge treatment section 203 may be configured to achieve the layout as shown in FIG. 7. For this purpose, for example, the mask 213 may be provided with a movable part or the corona discharge treatment section 203 itself may be divided into two or more sections separated in the width direction.

The aluminum foil 133 with the surface differentiated into the regions 134 and the region 135 in the corona discharge treatment section 203 is then subjected to coating process of active material mixture paste in the die-coating section 205. The mixture paste coating process is performed on the surface having been subjected to the corona discharge treatment in the corona discharge treatment section 203. In the drying furnace 206, the mixture paste is dried. Consequently, the positive electrode mixture layer 31 is formed. The aluminum foil 133 formed with the positive electrode mixture layer 31 is wound up once in the wind-up roll 207. The aluminum foil 133 is then passed again through the apparatus of FIG. 12 to form the positive electrode mixture layer 31 on the back surface in the same way. Thereafter, pressing of the positive electrode mixture layer 31 and cutting at the lines 136 and 137 shown in FIGS. 6, 8, and 11 are conducted, and then subjected to finishing of the electrode wound body 3.

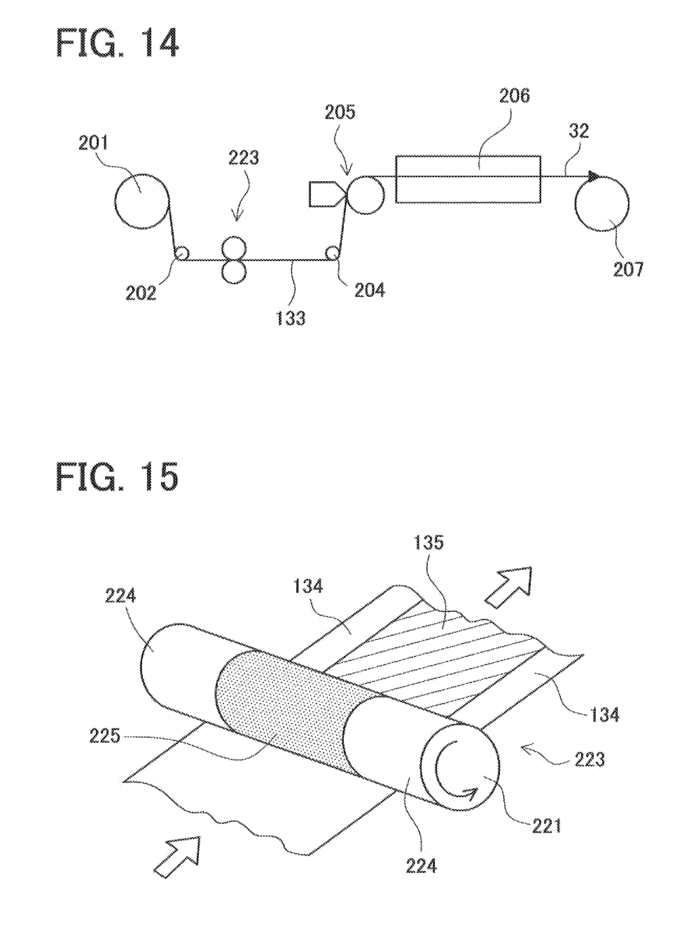

FIG. 14 shows an apparatus structure for differentiating by roughening treatment. The apparatus of FIG. 14 is identical in structure to the apparatus of FIG. 12 except for the following points. Specifically, in the apparatus of FIG. 14, a roughening treatment section 223 is provided instead of the corona discharge treatment section 203 of the apparatus of FIG. 12. The roughening treatment section 223 includes a roughening roller 221 shown in FIG. 15. The roughening roller 221 in FIG. 15 has a rough surface region 225 in the center in a width direction and smooth surface regions 224 on both sides of the rough surface region 225. The rough surface region 225 is a region formed, on its surface, with microscopic asperities and made of harder material than the aluminum foil. The width of the rough surface region 225 is equal to the width of the region 135 to be formed on the aluminum foil. The smooth surface regions 224 are regions each having a smooth surface. The smooth surface regions 224 are preferably made of flexible material such as rubber. The roughening roller 221 is placed so that the rough surface region 225 contacts a part of the aluminum foil in a width-direction range which will form the region 135.

The above apparatus of FIG. 14 having the roughening treatment section 223 can produce the aluminum foil 133 shown in FIG. 5. The roughening roller 221 may also be rendered movable to produce the aluminum foil 133 of FIG. 11. As another alternative, a plurality of roughening rollers including a movable roller(s) may be provided to produce the aluminum foil 133 of FIG. 7.

The apparatus in FIG. 12 or 14 can be designed for multiple-zone coating. Specifically, a target is an aluminum foil having a wide width corresponding to a total width of a plurality of aluminum foils shown in FIG. 5 and others, so that the positive electrode mixture layers 31 for the plurality of aluminum foils are formed at a time. The regions 134 and the regions 135 are also differentiated according to such a design. Further, an apparatus can be configured to perform differentiating by any other methods than the corona discharge treatment and the roughening treatment (see [0031]). For this purpose, a coating roller, a cleaning device, and others have only to be disposed appropriately instead of the corona discharge treatment section 203 and the roughening treatment section 223 in FIGS. 12 and 14. Further, the coating method is not limited to the die coating.

Subsequently, Examples according to the first embodiment will be explained. Firstly, common subject matters between Examples according to the first embodiment and Comparative Examples are listed below.

| | |
|---|---|
| Positive electrode sheet: | |
| Current collector sheet: | Aluminum foil having a |
| | thickness of 15 μm |
| Mixture solid content: | Mixture of three components |
| | listed below |
| Lithium Nickel Manganese | 90 parts by weight (pts. wt.) |
| Cobalt Oxide (*) | |
| Acetylene black | 8 pts. wt. |
| Polyvinylidene fluoride (PVDF) | 2 pts. wt. |

The item * has a mole ratio of Ni:Mn:Co = 1:1:1.

| | |
|---|---|
| Kneading solvent: | N-methyl-2-pyrolidone (NMP) |
| Coating method: | Die coating |
| Dimension of electrode sheet after | |
| pressing and slitting: | |
| Width of current collector sheet | 115 mm |
| Length | 3000 mm |
| Width of mixture layer | 95 mm |
| Thickness of mixture layer | 0.065 mm |
| Negative electrode sheet: | |
| Current collector sheet: | Copper foil having a thickness |
| | of 10 μm |
| Mixture solid content: | Mixture of three components |
| | listed below |
| Graphite | 98.6 pts. wt. |
| Carboxymethyl cellulose | 0.7 pts. wt. |
| (CMC, BSH-12) | |
| Styrene-butadiene rubber (SBR) | 0.7 pts. wt. |
| Kneading solvent: | Water |
| Coating method: | Die coating |
| Others: | |
| Separator: Three layers of PP/PE/PP | Total thickness of 20 μm |
| Electrolytic solution: | |
| Electrolyte: | LiPF₆ |
| Electrolytic solution: | Mixed liquid of three components |
| | listed below |
| Ethylene carbonate (EC) | 3 pts. wt. |
| Dimethyl carbonate (DMC) | 4 pts. wt. |
| Ethyl methyl carbonate (EMC) | 3 pts. wt. |
| Concentration: | 1.0M |
| Battery structure: | |
| Shape of electrode wound body: | Elliptic wound body |
| Shape of battery case: | Rectangular |
| Rating capacity: | 4.0 Ah |

### Example 1

An aluminum foil for forming a current collector sheet for positive electrode was subjected to the corona discharge treatment (the treatment apparatus in FIG. 12) to execute the continuous differentiating treatment shown in FIG. 5. A portion corresponding to the region 135 in FIG. 5 was subjected to the corona discharge treatment. The wettability of the aluminum foil of the current collector sheet was as below before and after the corona discharge treatment.

| | |
|---|---|
| Before treatment: | 32 dyne/cm (corresponding to the wettability |
| | NA of the region 134) |
| After treatment: | 54 dyne/cm (corresponding to the wettability |
| | NB of the region 135) |

Specifically, in Example 1, the wettability ratio, NA/NB, is about 0.59.

### Example 2

An aluminum foil for forming a current collector sheet for positive electrode was subjected to the roughening, instead of the corona discharge treatment, to execute the continuous differentiating treatment shown in FIG. 5. A portion corresponding to the region 135 in FIG. 5 was roughened with a roughening roller provided microscopic asperities on its surface. The wettability of the aluminum foil of the current collector sheet was as below with and without the roughening treatment.

Without roughening: 32 dyne/cm (corresponding to the wettability NA of the region 134)
With roughening: 36 dyne/cm (corresponding to the wettability NB of the region 135)
Specifically, in Example 2, the wettability ratio, NA/NB, is about 0.89.

### Example 3

An aluminum foil for forming a current collector sheet for positive electrode was subjected to oil coating, instead of the corona discharge treatment, to execute the continuous differentiating treatment shown in FIG. 5. Portions corresponding to the regions 134 in FIG. 5 were coated with oil. The coating oil used therein was Aqua Press B-2S by AQUA CHEMICAL CO., LTD. The wettability of the aluminum foil of the current collector sheet was as below with and without oil coating.

| | |
|---|---|
| With coating: | 28 dyne/cm (corresponding to the |
| | wettability NA of the region 134) |
| Without coating: | 32 dyne/cm (corresponding to the |
| | wettability NB of the region 135) |

Specifically, in Example 3, the wettability ratio, NA/NB, is about 0.88.

### Example 4

An aluminum foil for forming a current collector sheet for positive electrode was subjected to coating of water repellent material, instead of the corona discharge treatment, to execute the continuous differentiating treatment shown in FIG. 5. Portions corresponding to the regions 134 in FIG. 5 were coated with the water repellent material. The water repellent material used therein was fluorine contained resin. The wettability of the aluminum foil of the current collector sheet was as below with and without coating of the water repellent material.

With coating: 22.6 dyne/cm (corresponding to the wettability NA of the region 134)
Without coating: 32 dyne/cm (corresponding to the wettability NB of the region 135)
Specifically, in Example 4, the wettability ratio, NA/NB, is about 0.71.

### Example 5

An aluminum foil for forming a current collector sheet for positive electrode was subjected to the corona discharge treatment and the oil coating in combination to execute the continuous differentiating treatment shown in FIG. 5. A portion corresponding to the region 135 in FIG. 5 was subjected to the corona discharge treatment and portions corresponding to the regions 134 were subjected to the oil coating. The oil used therein was the same as that in Example 3. The wettability of the aluminum foil of the current collector sheet was as below in the portion subjected to the corona discharge treatment and the portions subjected to the oil coating.

| | |
|---|---|
| Oil coating: | 28 dyne/cm (corresponding to the wettability |
| | NA of the region 134) |
| Corona discharge treatment: | 54 dyne/cm (corresponding to the |
| | wettability NB of the region 135) |

Specifically, in Example 5, the wettability ratio, NA/NB, is about 0.52.

### Example 6

An aluminum foil for forming a current collector sheet for positive electrode was subjected to the corona discharge treatment and the coating with water repellent material in combination to execute the continuous differentiating treatment shown in FIG. 5. A portion corresponding to the region 135 in FIG. 5 was subjected to the corona discharge treatment and portions corresponding to the regions 134 were coated with the water repellent material. The water repellent material used therein was the same as that in Example 4. The wettability of the aluminum foil of the current collector sheet was as below in the portion subjected to the corona discharge treatment and the portions subjected to the water repellent material coating.

| | |
|---|---|
| Water repellent material coating: | 22.6 dyne/cm (corresponding to the |
| | wettability NA of the region 134) |
| Corona discharge treatment: | 54 dyne/cm (corresponding to the |
| | wettability NB of the region 135) |

Specifically, in Example 6, the wettability ratio, NA/NB, is about 0.42.

### Example 7

An aluminum foil for forming a current collector sheet for positive electrode was subjected to intermittent corona discharge treatment to execute the differentiating shown in FIG. 10. Each portion corresponding to the region 135 in FIG. 10 was subjected to the corona discharge treatment. This corona discharge treatment was performed on opposite portions on the front and back surfaces. As explained in FIG. 11, a portion subjected to the corona discharge treatment was disposed on the outermost circumference of the electrode wound body. The wettability of the aluminum foil of the current collector sheet was equal to that in Example 1. In Example 7, specifically, the wettability ratio, NA/NB, is about 0.59.

### Comparative Example 1

An aluminum foil for forming a current collector sheet for positive electrode was not subjected to any wettability adjusting treatment such as the corona discharge treatment and was directly subjected to coating of a positive electrode mixture layer. The wettability of the aluminum foil of the current collector sheet was equal to a value measured before the corona discharge treatment in Example 1. Specifically, in Comparative example 1, the differentiating for producing a wettability difference was not performed, and the wettability ratio, NA/NB, is 1.0.

### Comparative Example 2

An aluminum foil for forming a current collector sheet for positive electrode was subjected to the corona discharge treatment on an entire surface. The wettability of the aluminum foil of the current collector sheet after treatment was equal to a value measured after the corona discharge treatment in Example 1. Specifically, in Comparative example 2, similarly, the differentiating for producing a wettability difference was not performed, and the wettability ratio, NA/NB, is 1.0.

Each of the foregoing Examples and Comparative examples was subjected to the following three evaluation tests.
Measurement of voltage failure generation rate in completed battery
Stability test of coating width of mixture layer in current collector sheet for positive electrode
Evaluation of cross-sectional shape of width-direction end portion of mixture layer in current collector sheet for positive electrode

The measurement of voltage failure generation rate was conducted according to the following method. Specifically, two hundred batteries were produced in each of Examples and Comparative examples, and tested by the following sequence.

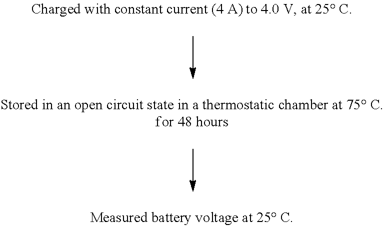

An average value Vave of voltage and a standard deviation σ of two hundred batteries in Comparative example 1 were calculated. Accordingly, a voltage value given by the following expression was set as criteria voltage:

Criteria voltage=Vave−3σ

The batteries lower in voltage than the criteria voltage were evaluated as failure, and the failure rate in each of Examples and Comparative examples was calculated.

The stability test of coating width was conducted as follows. Specifically, a width-direction end portion of the mixture layer of a produced electrode sheet was observed through a microscope over the length of 1 m in the longitudinal direction. It was then checked whether or not the portion of the mixture layer greatly indented more than 0.6 mm in the width direction. That is, it was checked whether the linearity of the end portion was good or not.

The evaluation of the cross sectional shape of the width-direction end portion of the mixture layer was executed as below. Specifically, a produced electrode sheet was embedded in resin and the cross section was observed through a microscope. And, the dimension L explained in FIG. 4 (see [0024], hereinafter referred to “L-dimension”) was measured. An average value of the L-dimensions of two hundred electrode sheets in each of Examples and Comparative examples was set as each measurement value. In Example 7, the cross-sectional shape evaluation was performed on a portion of the aluminum foil at a position in the longitudinal direction, the portion having been subjected to the corona discharge treatment and differentiated into the region 134 and the region 135.

TABLE 1

| | Wettability NA | Wettability NB | | L-dimension | Voltage | | |
|---|---|---|---|---|---|---|---|
| | of Uncoated | of Coated | | of End por- | failure | Stability | |
| | portion | portion | | tion shape | rate | of Coating | Comprehensive |
| | (dyne/cm) | (dyne/cm) | NA/NB | (μm) | (%) | width | Evaluation |
| CEx 1 | 32 | 32 | 1.00 | 118 | 1.5 | ◯ | X |
| CEx 2 | 54 | 54 | 1.00 | 147 | 2 | ◯ | X |
| Ex l | 32 | 54 | 0.59 | 63 | 0 | ◯ | ⊚ |
| Ex 2 | 32 | 36 | 0.89 | 92 | 0 | ◯ | ⊚ |
| Ex 3 | 28 | 32 | 0.88 | 89 | 0 | ◯ | ⊚ |
| Ex 4 | 22.6 | 32 | 0.71 | 75 | 0 | ◯ | ⊚ |
| Ex 5 | 28 | 54 | 0.52 | 57 | 0 | ◯ | ⊚ |
| Ex 6 | 22.6 | 54 | 0.42 | 48 | 0 | X | ◯ |
| Ex 7 | 32 | 54 | 0.59 | 63 | 0 | ◯ | ⊚ |

CEx: Comparative example,
Ex: Example

The measurement results are shown along with the wettability values in Table 1. As seen in the column of L-dimension in Table 1, the L-dimension in each of Comparative examples 1 and 2 exceeds 100 μm and thus is too large. This is conceived because differentiating of wettability was not conducted in Comparative examples 1 and 2, that is, the ratio of NA/NB is 1. Thus, the comprehensive evaluation of Comparative examples 1 and 2 is rated as “x (no-good)” in Table 1. In each of Examples 1 to 7 (NA/NB is 0.42 to 0.89) other than Comparative examples 1 and 2, the L-dimension is below 100 μm. Comparing Examples 1 to 7 in detail, it is found that the smaller the ratio of NA/NB, the smaller the L-dimension.

As seen in the column entitled “Voltage failure rate” in Table 1, all the values are 0% except for the values, 1.5 to 2%, in Comparative examples 1 and 2. The reason why the voltage failure occurred in Comparative examples 1 and 2 is conceived that the width of each portion defined by L is too large as described above. The reason why no voltage failure occurred in Examples 1 to 7 is conceived that the width of each portion defined by L is 100 μm or less, which is a good result.

As seen in the column entitled “Stability of coating width” in Table 1, only Example 6 is rated as “x (no-good)” and others are rated as “◯(good)”. This is because in Example 6 there was found one portion indented by a distance slightly exceeding 0.6 mm in the end portion of the mixture layer. In other Examples than Example 6, there was not found any portion indented by a distance exceeding 0.6 mm. Thus, Example 6 is understood that the stability of coating width is poorer than those in other Examples. This is conceivably because the wettability ratio of NA/NB between the region 134 and the region 135 is 0.42, which is extremely lower than those in other Examples. In other words, it is understood that a wettability difference between the region 134 and the region 135 is slightly excessive.

However, such an extent of the generation condition of the indented portion could not be always assessed as a defective product depending on use of a battery. Accordingly, Example 6 is rated as “◯”, not “x”, in the comprehensive evaluation in Table 1. On the other hand, Examples 1 to 5 and 7 exhibiting nonproblematic results in both of the L-dimension and the stability of coating width are rated as “⊚(very good)” in the comprehensive evaluation. From the foregoing results, the ratio of NA/NB has to be a value less than 1. In addition, also considering the coating width stability, the ratio of NA/NB is preferably a value larger than 0.5.

Table 1 also reveals that Example 7 in which the corona discharge treatment was intermittently performed could obtain the equivalent result to Example 1. Example 1 is identical to Example 7 except for continuous execution of the corona discharge treatment. Accordingly, it is confirmed that differentiating into the region 134 and the region 135 is required only to be performed to only a portion which will be disposed on an outermost circumference of an electrode wound body as explained in FIGS. 7 to 11.

### Second Embodiment

Next, a second embodiment, that is, a method using specially prepared mixture paste will be explained. The reason why a thin layer region is generated in an end portion of a mixture layer is in short that the mixture paste is fluid material. Naturally, as the viscosity of the mixture paste is lower, the thin layer region is more likely to be remarkably generated. This is because the mixture paste low in viscosity is likely to flow. In this sense, it is preferable that the viscosity of mixture paste is higher in order to prevent the thin layer region from being generated widely in the end portion of the mixture layer.

However, the high viscosity of the mixture paste will conversely cause difficulty in coating the mixture paste onto the aluminum foil (the process in the foregoing die-coating section 205). To flatly apply the mixture paste onto the aluminum foil, the fluidity of the mixture paste has to be high to some extent.

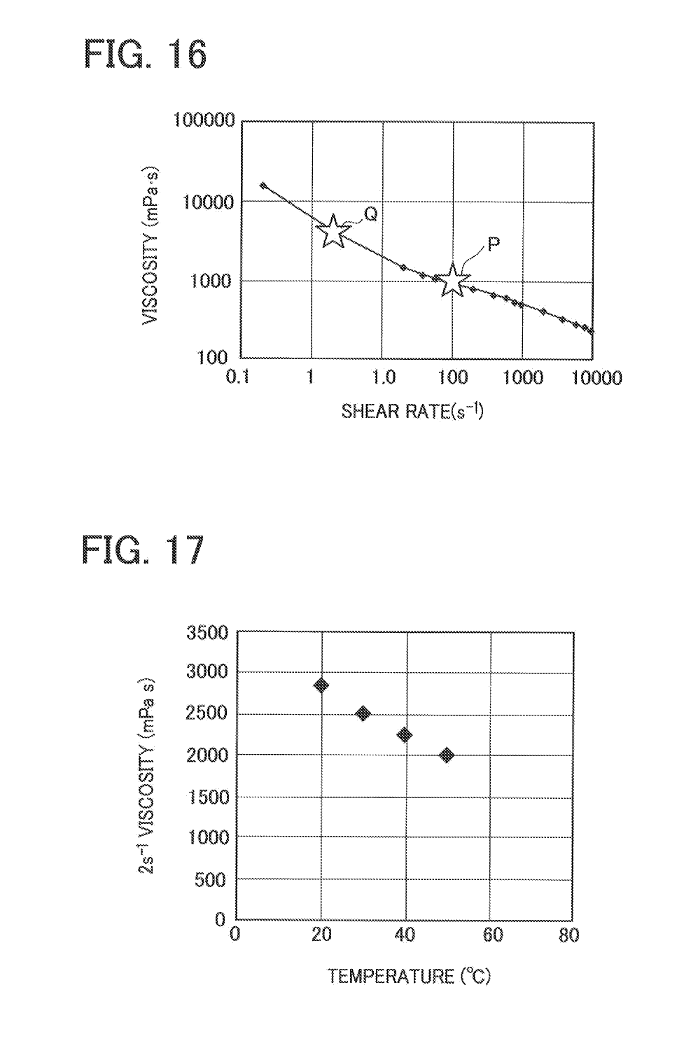

Meanwhile, it is known that the viscosity of fluid material such as the mixture paste depends on a shear rate or velocity in a stirring operation. The mixture paste of positive active material to be used for forming the positive electrode mixture layer 31 in the positive electrode sheet 32 has generally a viscosity characteristic as shown in a graph of FIG. 16. In FIG. 16, a horizontal axis indicates the shear rate and a vertical axis indicates the viscosity. This graph exhibits a thixotropy property that the viscosity decreases as the shear rate increases.

In the case of the mixture paste used to form the positive electrode mixture layer 31 as in the present embodiment, a state thereof during coating is equivalent to a state under being stirred at a shear rate of the order of approximately 100 sec⁻¹ and a state after coating is equivalent to a state under being stirred at a shear rate of the order of approximately 2 sec⁻¹. To perform the coating process without difficulty, therefore, the viscosity at the shear rate of 100 sec⁻¹ (a star mark P in FIG. 16, hereinafter referred to as “100 s⁻¹ viscosity”) is desirably low. On the other hand, to avoid the generation of a large thin layer region in the end portion of the mixture layer after coating, the viscosity at the shear rate of 2 sec⁻¹ (a star mark Q in FIG. 16, hereinafter referred to as “2 s⁻¹ viscosity”) is desirably high.

Specifically, the mixture paste used to form the positive electrode mixture layer 31 is desired to make a somewhat remarkable difference between the star marks P and Q in FIG. 16. In the second embodiment, therefore, for the positive electrode mixture paste to be used, a parameter; a ratio between the 100 s⁻¹ viscosity (V100) and the 2 sec⁻¹ viscosity (V2), V2/V100, is introduced. This parameter is referred to as a TI (thixotropy index) value.

In the second embodiment, the positive electrode mixture paste prepared to have a high TI value to some extent is used. Accordingly, the viscosity of the mixture paste is low, thus easy to coat, during coating, and, is high to some extent on the aluminum foil, thus difficult to flow, after coating. Thus, the thin layer region will not be formed largely in the end portion of the mixture layer. However, if the TI value is too high, the flatness of the flat region 31F of the positive electrode mixture layer 31 to be finished will be poor. This is because the fluidity of the coated mixture paste is low on the current collector sheet. For this reason, the TI value of the mixture paste has a preferable range; that is, a range of 1.7 to 4.6 as mentioned later.

In the second embodiment, furthermore, also in the drying process following the coating process, special heating process is performed to avoid the generation of a thin layer region in the end portion of the mixture layer. This is because, in the drying process, when the temperature of the mixture paste just coated rises, this rise in temperature causes the viscosity of the mixture paste to go down. A graph of FIG. 17 shows a relationship between the temperature and the viscosity of the mixture paste. It is revealed from this graph that the viscosity of the mixture paste lowers as the temperature rises. In the drying process, accordingly, if the temperature excessively rises before the mixture paste is fully dried and solidified, the mixture paste in the end portion will flow, resulting in the generation of a large thin layer region.

In the drying process of the second embodiment, therefore, a temperature difference is produced between the end portion and the central portion of the mixture layer in a coating width before entering in the drying furnace or at an initial stage of drying. This prevents the temperature of the end portion from greatly rising, but causing mainly the temperature of the central portion in the coating width to rise. The mixture paste is dried in this manner. Accordingly, the drying treatment is promoted while keeping the viscosity of the mixture paste in the end portion in the coating width from greatly declining. Even in the course of the drying treatment, the thin layer region in the end portion of the mixture layer will not become so wide.

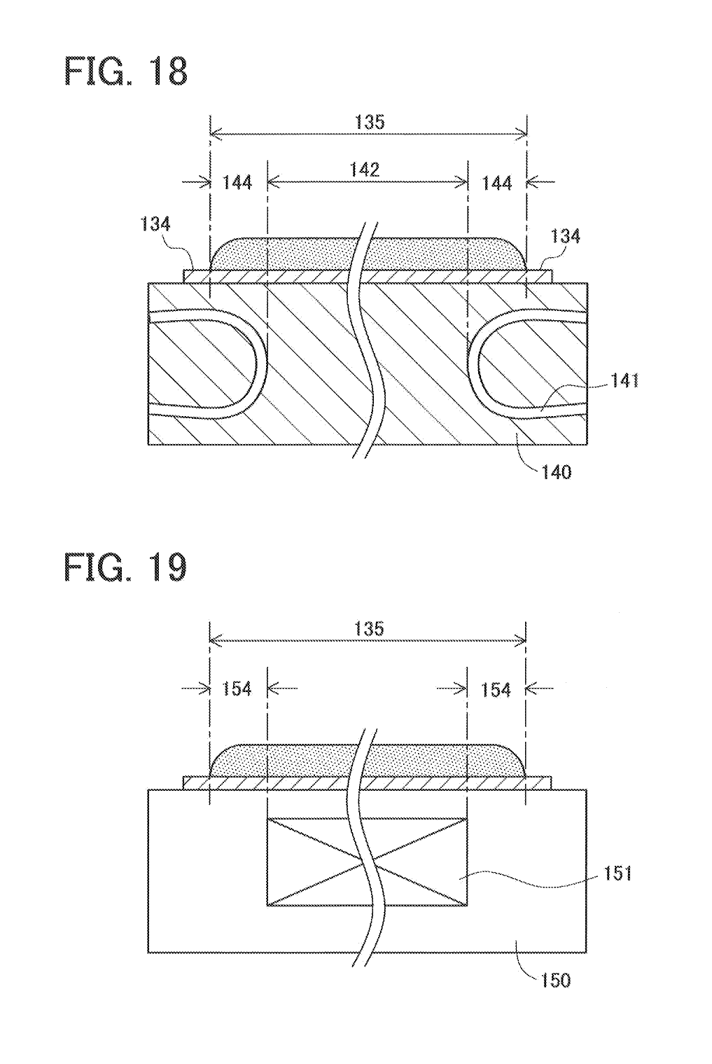

In the second embodiment, in order to achieve a temperature difference between the end portion and the central portion, a special designed supporting roller can be used to support an aluminum foil after coating. The special supporting roller is as shown in FIG. 18 or 19.

A supporting roller 140 in FIG. 18 is a roller designed to cool each end portion (end-portion cooling type). The supporting roller 140 in FIG. 18 is internally provided with water paths 141. The water paths 141 are provided in both ends of the supporting roller 140 in the width direction. That is, the width-direction end portions of the supporting roller 140 provide cooling zones, between which a non-cooling region 142 provided with no water path 141 is present. Further, a penetration width 144 of each water path 141 into a part of the supporting roller 140 supporting the region 135 (the region having the positive electrode mixture layer 31) of the aluminum foil is about 10 mm at each of the right and left sides. Needless to say, the supporting roller 140 carries the aluminum foil while flowing cooling water (or any coolant other than water) through each water path 141.

When the aluminum foil after coating is supported and delivered by the supporting roller 140 of FIG. 18, the aluminum foil under delivery is given a temperature difference in the width direction as below. Specifically, the aluminum foil located in a range corresponding to each of the water paths 141 at both ends in the width direction is relatively low in temperature because of the cooling function of the cooling water. Thus, the portion of the aluminum foil corresponding to a width 144 of about 10 mm in each width-direction end portion of the mixture paste coated on the aluminum foil is also relatively low in temperature, so that the viscosity thereof is maintained at a high level. On the other hand, on the non-cooling region 142 between the both water paths 141, the temperature is relatively high because of no cooling action of the cooling water, and evaporation of solvent components from the mixture paste is prompted. Specifically, in the supporting roller 40, the regions having the water paths 141 in the width direction are low-temperature regions and the non-cooling region 142 having no water path 141 is a high-temperature region.

A supporting roller 150 in FIG. 19 is a roller designed to heat the central portion (central-portion heating type) with a built-in heater. The supporting roller 150 in FIG. 19, different from that in FIG. 18, is not provided with the water paths 141. Instead, the supporting roller 150 is internally provided with a heater 151. The heater 151 is located at the center in the width direction, different from the water paths 141 located at both ends in the width direction. Specifically, in the supporting roller 150, there are provided a heating zone at the center in the width direction and non-heating zones at both ends. Needless to say, the supporting roller 150 carries the aluminum foil while heating the aluminum foil by the heater 151. In the supporting roller 150, therefore, the width-direction central portion is a high-temperature region and the both end portions are low-temperature regions according to the presence/absence of heating by the heater 151. Each protrusion width 154 of the coating region 135 from the width of the heater 151 is nearly equal to the width 144 in FIG. 18.

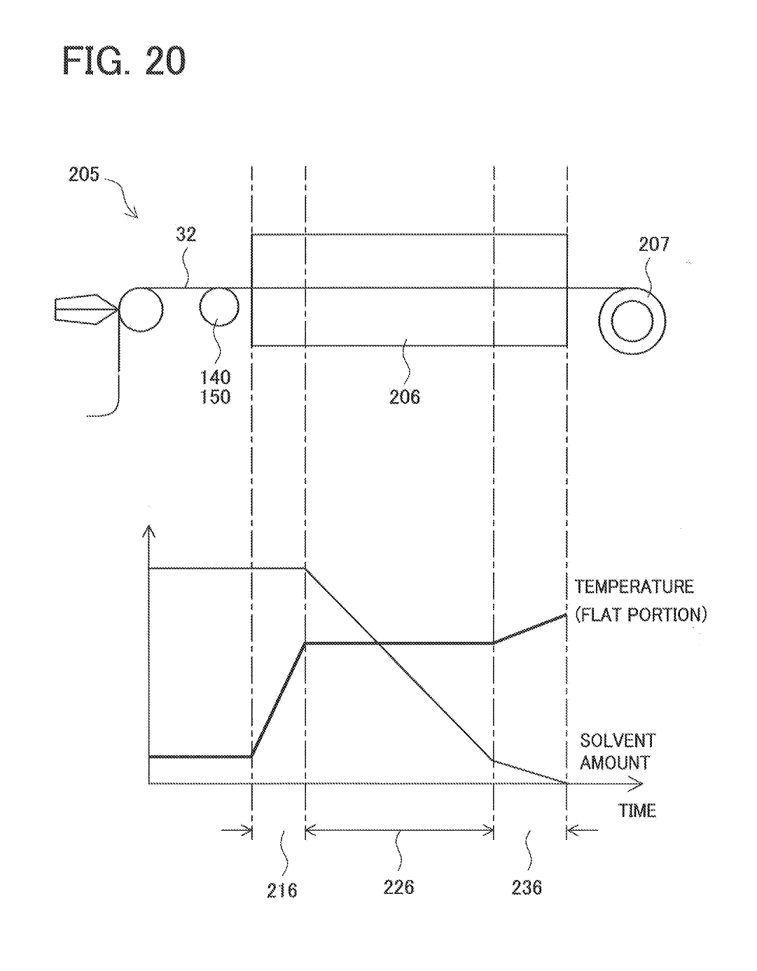

The second embodiment employs an apparatus configured by removing the corona discharge treatment section 203 or the roughening treatment section 223 from the apparatus shown in FIG. 12 or 14. A part of this apparatus, from the die-coating section 205 and subsequent, is shown in an upper half of FIG. 20. In this structure, the supporting roller 140 or 150 is placed in contact with the back surface of the positive electrode sheet 32 at a position after the die-coating section 205 but before the drying furnace 206.

The positive electrode sheet 32 given the foregoing temperature difference in the width direction thus enters the drying furnace 206. In the course of the drying process, particularly at an initial stage in the drying furnace 206, the thin layer region in the end portion of the mixture layer is prevented from widening as described in [0083]. At a middle stage and subsequent in the drying course, the temperature difference in the width direction gradually diminishes. At that time, the solvent amount in the mixture paste has already decreased to some extent. Therefore, even when the temperature of the mixture paste rises in the end portion in the width direction, it does not lead to widening of the thin layer region, because the mixture paste has already started to harden.

In a lower half of FIG. 20, a graph shows transition of the temperature and the remaining solvent amount in the mixture layer 31 of the positive electrode sheet 32 in passing through the drying furnace 206. The temperature shown herein is the temperature of the flat portion at the center in the width direction. In this example, the supporting roller used before the drying furnace 206 is the supporting roller 140 of the end-portion cooling type shown in FIG. 18.

In a pre-heating period 216 in which the positive electrode sheet 32 having just entered the drying furnace 206, the temperature of the mixture layer 31 sharply rises, but the solvent amount does not so decrease. This is because the temperature itself in this period is not so high. At that time, the mixture layer 31 has been given the temperature difference by the supporting roller 140, so that the thin layer region does not widen. In a constant-rate drying period 226 following the pre-heating period 216, the temperature gets nearly saturated to a constant value. Thus, the solvent amount nearly linearly decreases. For this period, even though the temperature difference by the supporting roller 140 has significantly weakened, the decrease in solvent amount makes the mixture paste less likely to flow. Accordingly, the thin layer region also does not expand.

In a decreasing drying period 236 corresponding to an end stage of the drying furnace 206, the speed of decreasing the solvent amount slows down, because the remaining solvent amount comes to zero. Simultaneously, the temperature of the mixture layer 31 slightly rises again. This is because vaporization heat caused by the evaporating solvent decreases. At this time, the temperature difference by the supporting roller 140 has already nearly disappeared, but the mixture layer 31 itself is no longer hardly fluid. Accordingly, the thin layer region also does not widen. In the second embodiment, the generation of a large thin layer region in the end portion of the mixture layer 31 can be thus prevented.

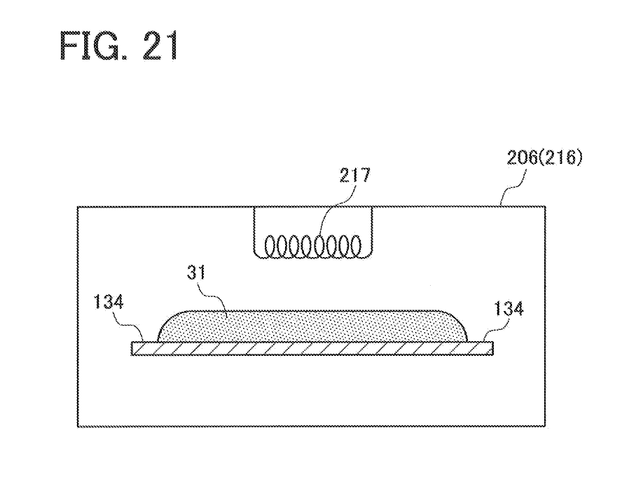

Instead of providing the supporting roller 140 or 150 in front of an entrance of the drying furnace 206, it may be provided within the region for the pre-heating period 206 (first one-sixth to first one-quarter of the total length of the drying furnace 206) in the drying furnace 206. However, it is meaningless to provide the supporting roller 140 or 150 in a position corresponding to the constant-rate drying period 226 or the decreasing-rate drying period 236. Further, instead of providing the supporting roller 140 or 150, a heater 217 (or a hot-air blowing port) may be provided within the region for the pre-heat period 216 in the drying furnace 206 so that the heater 217 faces to only the central portion of the mixture layer 31 as shown in FIG. 21.

Next, examples of the second embodiment will be explained. The common subject matters of the examples of the first embodiment (see [0052]-[0055]) are also basically common for each of the examples and comparative examples in the second embodiment. In the second embodiment, similarly, two hundred batteries were produced in each of Examples and Comparative examples, and subjected to tests.

In the second embodiment, additionally, the mixture paste for the positive electrode was adjusted in TI value as described in [0080] according to kneading time. Specifically, a longer kneading time produces a mixture paste having a lower TI value, while a shorter kneading time produces a mixture paste having a higher TI value. For kneading, a planetary mixer was used. The positive electrode mixture paste after kneading was subjected to measurement of the viscosity at two-level shear rates, of the order of 100 sec⁻¹ and 2 sec⁻¹, and the TI values were calculated from those measurement results. For this viscosity measurement, a “Physica MCR301” by Anton Paar was used.

### Example 8

The kneading time of the positive electrode mixture paste was set to 90 min. to prepare a mixture paste having a TI value of 1.8. As the supporting roller located before the drying furnace 206, a normal roller, not a special one shown in FIG. 18 or 19, was used. The hot-air temperature in the drying furnace 206 was set to 150° C.

### Example 9

The kneading time of the positive electrode mixture paste was set to 60 min. to prepare a mixture paste having a TI value of 2.7. Other conditions were the same as those in Example 8.

### Example 10

The kneading time of the positive electrode mixture paste was set to 40 min. to prepare a mixture paste having a TI value of 3.6. Other conditions were the same as those in Example 8.

### Example 11

The kneading time of the positive electrode mixture paste was set to 30 min. to prepare a mixture paste having a TI value of 4.5. Other conditions were the same as those in Example 8.

### Example 12

As the supporting roller placed before the drying furnace 206, the end-portion cooling supporting roller 140 shown in FIG. 18 was used. Other conditions were the same as those in Example 9.

### Example 13

As the supporting roller placed before the drying furnace 206, the central-portion heating supporting roller 150 shown in FIG. 19 was used. The hot-air temperature in the drying furnace 206 was set to 140° C. Other conditions were the same as those in Example 9.

### Comparative Example 3

The kneading time of the positive electrode mixture paste was set to 120 min. to prepare a mixture paste having a TI value of 1.3. Other conditions were the same as those in Example 8.

### Comparative Example 4

The kneading time of the positive electrode mixture paste was set to 20 min. to prepare a mixture paste having a TI value of 5.5. Other conditions were the same as those in Example 8.

Each of the foregoing Examples and Comparative examples was subjected to the following three evaluation tests.
Measurement of voltage failure generation rate in completed battery
Evaluation of cross-sectional shape of width-direction end portion of mixture layer in current collector sheet for positive electrode
Test on cycle characteristics of completed battery
   The measurement of voltage failure generation rate and the evaluation of cross-sectional shape are the same as in the tests performed in Examples in the foregoing first embodiment.

The cycle characteristic test was conducted according to the following method. The batteries were firstly charged and discharged at 25° C. as below, and respective initial battery capacities were calculated.

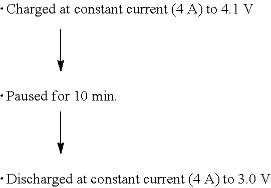

Subsequently, the following steps was defined as one cycle, and charge and discharge were repeated by 1000 cycles at 60° C.

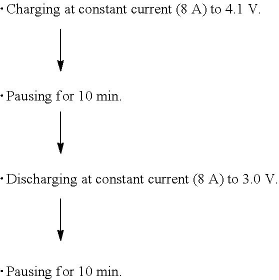

The batteries having undergone 1000 cycles were subjected again to charge and discharge as described in [0105], and then the battery capacity after cycles were calculated. Capacity maintenance ratios were calculated by the following expression and an average of them was determined as the capacity maintenance ratio in each of Examples and Comparative examples.

Capacity maintenance ratio=Battery capacity after cycles/Initial battery capacity

TABLE 2

| | | | | | | | Cycle | |
|---|---|---|---|---|---|---|---|---|
| | | | | | L-dimension | Voltage | characteristic | |
| | Kneading | Paste | | Drying furnace | of End por- | failure | Capacity main- | |
| | time | TI | Supporting | Hot-air temp. | tion shape | rate | tenance ratio | Comprehensive |
| | min. | value | roller | ° C. | (μm) | (%) | % | Evaluation |
| CEx 3 | 120 | 1.3 | N | 150 | 115 | 2 | 95 | X |
| Ex 8 | 90 | 1.8 | N | 150 | 73 | 0 | 94 | ◯ |
| Ex 9 | 60 | 2.7 | N | 150 | 65 | 0 | 92 | ◯ |
| Ex 10 | 40 | 3.6 | N | 150 | 60 | 0 | 91 | ◯ |
| Ex 11 | 30 | 4.5 | N | 150 | 56 | 0 | 88 | ◯ |
| CEx 4 | 20 | 5.5 | N | 150 | 49 | 0 | 73 | X |
| Ex 12 | 60 | 2.7 | Y | 150 | 55 | 0 | 92 | ◯ |
| Ex 13 | 60 | 2.7 | Z | 140 | 58 | 0 | 95 | ◯ |

CEx: Comparative example,
Ex: Example
N: Normal,
Y: End-portion cooling type,
Z: Central-portion heating type

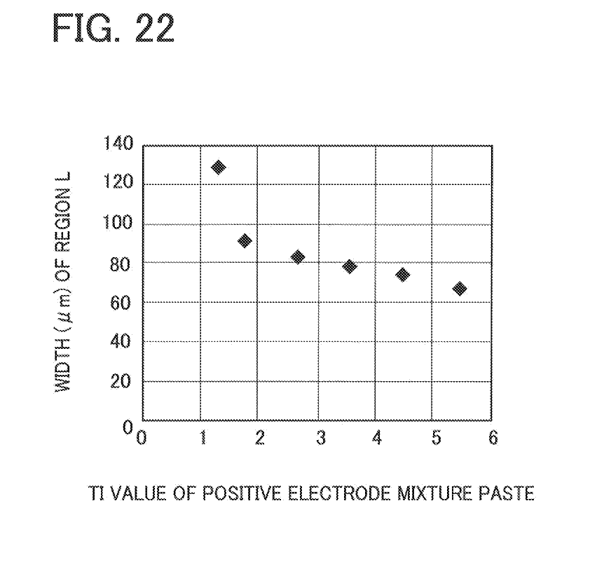

Measurement results are shown together with TI values of mixture paste and others in Table 2. FIG. 22 is a graph showing a relationship between the TI values of mixture paste and the L-dimension of an end portion cross sectional shape in Table 2. In FIG. 22, a horizontal axis indicates TI value and a vertical axis indicates L-dimension. According to FIG. 22, it is revealed that, as the TI value of the mixture paste is higher, the width of a portion defined by “L” in the end portion of the mixture layer is smaller. This result meets the explanation in [0080]. The width of the “L” portion needs to be 100 μm or less as explained in [0024]. The L-dimension in Comparative example 3 is 115 μm, which exceeds 100 μm, and thus is not good. From this point of view, Comparative example 3 (TI value: 1.3) is rated as “x (no-good)” in the comprehensive evaluation in Table 2.

In every example (Examples 8-13, Comparative example 4, TI value: 1.8 to 5.5) other than Comparative example 3, the L-dimension was below 100 μm. Of them, Example 8 exhibited a lowest TI value and a large L-dimension (TI value: 1.8, L-dimension: 73 μm). Since a large difference in L-dimension is found between Example 8 and Comparative example 3 by comparison, an allowable lower limit of the TI value is conceived to be about 1.7, slightly lower than the TI value in Example 8.

As seen in the column entitled “Voltage failure rate” in Table 2, all the values are 0% except for 2% in Comparative example 3. The reason why the voltage failure occurred in Comparative example 3 is conceived that the width of the L-portion is too large as described above. The reason why no voltage failure occurred in other examples than Comparative example 3 is conceived that the width of the L-portion is 100 μm or less and the relevant examples were good in this respect.

As seen in the column entitled “Capacity maintenance ratio” in Table 2, all results was as good as 88% or better except for Comparative example 4 exhibiting a value as low as 73%. The reason why the capacity maintenance rate was not good in Comparative example 4 is conceived that the TI value of the used positive electrode mixture paste is 5.5, which is too high. From this, it is presumed that the flatness of the flat region 31F of the finished positive electrode mixture layer 31 was poor, causing non-uniform reaction of a battery to charge and discharge. Thus, Comparative example 4 is rated as “x (no-good)” in the comprehensive evaluation in Table 2.

On the other hand, the capacity maintenance ratio in each of the examples (Example 8-13, Comparative example 3, TI value: 1.3 to 4.5) other than Comparative example 4 was good because the TI values of respective positive electrode mixture pastes were not excessively large. Accordingly, it is presumed that the flatness of the flat region 31F of the positive electrode mixture layer 31 was good, causing no non-uniform reaction of a battery to charge and discharge. Of them, Example 11 exhibits a highest TI value and a lowest capacity maintenance ratio (TI value: 4.5, Capacity maintenance ratio: 88%). Since a relatively large difference in capacity maintenance ratio is found between Example 11 and Comparative example 4 by comparison, an allowable upper limit of the TI value is conceived to be about 4.6, slightly higher than the TI value in Example 11.

From the above results, except for Comparative example 3 with a poor result in L-dimension of the end portion shape and Comparative example 4 with a poor result in capacity maintenance ratio, Examples 8-13 are rated as “◯ (good)” in the comprehensive evaluation in Table 2. Consequently, a preferable range of the TI value of the mixture paste is a range of 1.7 to 4.6.

Of Examples 8 to 13, Examples 12 and 13 each employing the special roller as the supporting roller disposed before the drying furnace 206 are further studied below. These Examples 12 and 13 are similar to Example 9 in terms of the TI value of the used mixture paste. However, in Examples 12 and 13, the obtained L-dimension was better than that in Example 9. In Examples 12 and 13, specifically, the L-dimension equivalent to those in Examples 10 and 11 employing the mixture paste having higher TI values could be obtained. In addition, in Examples 12 and 13, the capacity maintenance ratios are more excellent than those in Examples 10 and 11. Example 13 employing the supporting roller of the central-portion heating type, especially, exhibits the capacity maintenance ratio surpassing that in Example 8 employing the mixture paste having a lower TI value.

Such superior characteristics in Examples 12 and 13 are conceived to result from the use of the end-portion cooling type supporting roller shown in FIG. 18 or the central-portion heating type supporting roller shown in FIG. 19. In those Examples, specifically, the drying process is started after a temperature difference is produced between the end portions and the central portion of the coated mixture paste layer. This can achieve both small L-dimension and high capacity maintenance ratio at higher levels.

According to the foregoing embodiments explained in detail above, prior to the coating treatment of the positive electrode mixture layer, the aluminum foil for forming the current collector sheet for positive electrode is given a wettability difference between a portion to be formed as a coated portion and a portion to be formed as an uncoated portion. Alternatively, a positive electrode mixture paste to be used for coating is one prepared so that the TI value is a value falling within a predetermined high range to some extent. These achieve a width of 100 μm or less in the end edge region of the thin layer region in the width-direction end portion of the positive electrode mixture layer 31. Consequently, there are realized a non-aqueous electrolyte secondary battery configured to prevent a problem due to current concentration in an outermost circumferential portion of a positive electrode, a method for manufacturing a positive electrode sheet of the non-aqueous electrolyte secondary battery, and a method for manufacturing the non-aqueous electrolyte secondary battery.

The above-described embodiments are mere examples and do not give any limitations to the present invention. Thus, the present invention may be embodied in other specific forms without departing from the essential characteristics thereof. For instance, each part or component may be made of any material and a battery may have any outer shape as long as they can function as a non-aqueous electrolyte secondary battery. Further, producing a temperature difference on the positive electrode mixture paste layer after coating in the width direction, which is explained in the second embodiment, may also be applied to the first embodiment. Further, the first embodiment and the second embodiment may be combined.

### REFERENCE SIGNS LIST

1 Battery
3 Electrode wound body
4 Separator
22 Negative electrode sheet
31 Positive-electrode mixture layer
31F Flat region
31S End edge region
32 Positive electrode sheet
32C Outermost circumferential portion
34 Uncoated portion
140 Heating roller of end-portion cooling type
150 Heating roller of central-portion heating type
203 Corona discharge treatment section
205 Die-coating section
206 Drying furnace
223 Roughening treatment section

1. A non-aqueous electrolyte secondary battery having an electrode wound body including a positive electrode sheet and a negative electrode sheet, which are wound in overlapping relation with separators interposed therebetween,
wherein an outermost circumferential electrode sheet of the electrode wound body is the negative electrode sheet, and
the positive electrode sheet is configured such that a mixture layer formed on an outer surface of an outermost circumferential portion has an end portion in a width direction having a steep cross sectional shape in which a portion as thin as or thinner than 50% of a thickness of a flat portion of the mixture layer at a center in the width direction has a width of 92 μm or less.

2. A method for manufacturing a positive electrode sheet of a non-aqueous electrolyte secondary battery having an electrode wound body including a positive electrode sheet and a negative electrode sheet, which are wound in overlapping relation with separators interposed therebetween,
wherein the method comprises a coating step of coating positive electrode mixture paste onto a current collector sheet to form a mixture layer,
prior to the coating step, wettability adjusting treatment is performed on at least an outer surface of an outermost circumferential region of the current collector sheet in a longitudinal direction, the outermost circumferential region corresponding to a range which will be placed on an outermost circumference of the electrode wound body, to adjust a wettability value NA of a width-direction end portion to be formed as an uncoated portion and a wettability value NB of a width-direction central portion to be formed as a coated portion at a ratio NA/NB expressed by 0.5<NA/NB<1,
so that the mixture layer to be formed in the coating step has an end portion in a width direction having a steep cross sectional shape in which a portion as thin as or thinner than 50% of a thickness of a flat portion of the mixture layer at a center in the width direction has a width of 92 μm or less in at least the outermost circumferential region on a surface which will be an outer surface of the electrode wound body.

3. The method for manufacturing a positive electrode sheet of a non-aqueous electrolyte secondary battery according to claim 2,
wherein the wettability adjusting treatment includes at least one of a treatment of decreasing wettability of the width-direction end portion of the current collector sheet and a treatment of increasing wettability of the width-direction central portion of the current collector sheet,
the treatment of decreasing the wettability is an oil coating process or a water-repellent material coating process in the case where the decreasing treatment is performed, and
the treatment of increasing the wettability is one of a corona discharge treatment, a roughening treatment, and a cleaning treatment using solvent in the case where the increasing treatment is performed.

4. The method for manufacturing a positive electrode sheet of a non-aqueous electrolyte secondary battery according to claim 2,
wherein the wettability adjusting treatment is performed over an entire region of the current collector sheet in the longitudinal direction.

5. The method for manufacturing a positive electrode sheet of a non-aqueous electrolyte secondary battery according to claim 2,
wherein the wettability adjusting treatment is performed on only a range of an entire region of the current collector sheet in the longitudinal direction, the range being to be disposed on the outermost circumference of the electrode wound body.

6. A method for manufacturing a positive electrode sheet of a non-aqueous electrolyte secondary battery having an electrode wound body including a positive electrode sheet and a negative electrode sheet, which are wound in overlapping relation with separators interposed therebetween,
wherein the method comprises a coating step of coating positive electrode mixture paste onto a current collector sheet to form a mixture layer,
the coating step uses positive electrode mixture paste having a TI value falling within a range of 1.7 to 4.6, the TI value being a ratio between viscosity at a shear rate of 2 s⁻¹ and viscosity at a shear rate of 100 s⁻¹ at 20° C.,
so that the mixture layer to be formed in the coating step has an end portion in a width direction having a steep cross sectional shape in which a portion as thin as or thinner than 50% of a thickness of a flat portion of the mixture layer at a center in the width direction has a width of 92 μm or less.

7. The method for manufacturing a positive electrode sheet of a non-aqueous electrolyte secondary battery according to claim 6,
wherein the method comprises a drying step of drying the mixture layer formed in the coating step, and
on an entrance side in the drying step, the end portion of the mixture layer in the width direction is made lower in temperature than the central portion in the width direction.

8. The method for manufacturing a positive electrode sheet of a non-aqueous electrolyte secondary battery according to claim 7,
wherein a back surface of the current collector sheet after the coating step is supported by a supporting roller, and
the supporting roller is an end-portion cooling roller having cooling zones in end portions in a width direction and a non-cooling zone between the cooling zones.

9. The method for manufacturing a positive electrode sheet of a non-aqueous electrolyte secondary battery according to claim 7,
wherein a back surface of the current collector sheet after the coating step is supported by a supporting roller, and
the supporting roller is a central-portion heating roller having a heating zone in a central portion in a width direction and non-heating zones at both ends.

10. A method for manufacturing a non-aqueous electrolyte secondary battery using a positive electrode sheet manufactured by the manufacturing method according to claim 2, together with a negative electrode sheet and separators,
wherein the method comprises a winding step of winding the positive electrode sheet and the negative electrode sheet in overlapping relation with the separators interposed therebetween to form an electrode wound body, and
in the winding step,
the negative electrode sheet is disposed as an outermost circumferential electrode sheet of the electrode wound body, and
the portion having the steep cross sectional shape, of the end portion of the mixture layer in the width direction, is placed on at least an outer surface of an outermost circumferential portion of the positive electrode sheet.

11. The non-aqueous electrolyte secondary battery according to claim 1,
wherein the positive electrode sheet is configured such that a mixture layer formed on an outer surface of an outermost circumferential portion has an end portion in a width direction having the steep cross sectional shape in which the portion as thin as or thinner than 50% of the central thickness has a width of more than 49 μm.

12. The method for manufacturing a positive electrode sheet of a non-aqueous electrolyte secondary battery according to claim 2,
wherein the mixture layer to be formed in at least the outermost circumferential region on a surface which will be an outer surface of the electrode wound body in the coating step has the steep cross sectional shape in which the portion as thin as or thinner than 50% of the central thickness has a width of more than 49 μm.

13. The method for manufacturing of a non-aqueous electrolyte secondary battery according to claim 10,
wherein the mixture layer to be formed in at least the outermost circumferential region on a surface which will be an outer surface of the electrode wound body in the coating step has the steep cross sectional shape in which the portion as thin as or thinner than 50% of the central thickness has a width of more than 49 μm.

14. The method for manufacturing a positive electrode sheet of a non-aqueous electrolyte secondary battery according to claim 3,
wherein the mixture layer to be formed in at least the outermost circumferential region on a surface which will be an outer surface of the electrode wound body in the coating step has the steep cross sectional shape in which the portion as thin as or thinner than 50% of the central thickness has a width of more than 49 μm.

15. The method for manufacturing a positive electrode sheet of a non-aqueous electrolyte secondary battery according to claim 3,
wherein the wettability adjusting treatment is performed over an entire region of the current collector sheet in the longitudinal direction.

16. The method for manufacturing a positive electrode sheet of a non-aqueous electrolyte secondary battery according to claim 3,
wherein the wettability adjusting treatment is performed on only a range of an entire region of the current collector sheet in the longitudinal direction, the range being to be disposed on the outermost circumference of the electrode wound body.

17. The method for manufacturing a positive electrode sheet of a non-aqueous electrolyte secondary battery according to claim 6,
wherein the mixture layer to be formed in at least the outermost circumferential region on a surface which will be an outer surface of the electrode wound body in the coating step has the steep cross sectional shape in which the portion as thin as or thinner than 50% of the central thickness has a width of more than 49 μm.

18. The method for manufacturing a positive electrode sheet of a non-aqueous electrolyte secondary battery according to claim 7,
wherein the mixture layer to be formed in at least the outermost circumferential region on a surface which will be an outer surface of the electrode wound body in the coating step has the steep cross sectional shape in which the portion as thin as or thinner than 50% of the central thickness has a width of more than 49 μm.

19. A method for manufacturing a non-aqueous electrolyte secondary battery using a positive electrode sheet manufactured by the manufacturing method according to claim 6, together with a negative electrode sheet and separators,
wherein the method comprises a winding step of winding the positive electrode sheet and the negative electrode sheet in overlapping relation with the separators interposed therebetween to form an electrode wound body, and
in the winding step,
the negative electrode sheet is disposed as an outermost circumferential electrode sheet of the electrode wound body, and
the portion having the steep cross sectional shape, of the end portion of the mixture layer in the width direction, is placed on at least an outer surface of an outermost circumferential portion of the positive electrode sheet.

20. The method for manufacturing of a non-aqueous electrolyte secondary battery according to claim 19,
wherein the mixture layer to be formed in at least the outermost circumferential region on a surface which will be an outer surface of the electrode wound body in the coating step has the steep cross sectional shape in which the portion as thin as or thinner than 50% of the central thickness has a width of more than 49 μm.
